(19) United States
(12) Patent Application Publication
(10) Pub. No.: US 2014/0140391 A1
(43) Pub. Date: May 22, 2014

(54) IMAGE PROCESSING DEVICE, IMAGE PROCESSING METHOD, AND PROGRAM

(71) Applicant: Sony Corporation, Tokyo (JP)

(72) Inventors: Masashi Eshima, Tokyo (JP); Hiroshi Oryoji, Kanagawa (JP); Satoru Kuma, Tokyo (JP)

(73) Assignee: Sony Corporation, Tokyo (JP)

(21) Appl. No.: 14/078,561

(22) Filed: Nov. 13, 2013

(30) Foreign Application Priority Data
Nov. 21, 2012 (JP) 2012-254900

(51) Int. Cl. H04N 7/26

(52) U.S. Cl. CPC H04N 19/00903
USPC 375/240.01

(57) ABSTRACT

There is provided an image processing device including a generation unit configured to generate a combined stream, which is one encoded stream of a plurality of images generated from encoded streams of the plurality of images, from the encoded streams of the plurality of images according to a method corresponding to a process performed after decoding of the combined stream.

### CROSS REFERENCE TO RELATED APPLICATIONS

This application claims the benefit of Japanese Priority Patent Application JP 2012-254900 filed Nov. 21, 2012, the entire contents of which are incorporated herein by reference.

### BACKGROUND

The present technology relates to an image processing device, an image processing method, and a program, and more particularly, to an image processing device, an image processing method, and a program capable of generating a combined stream according to a method suitable when a process is performed after decoding of the combined stream.

In recent years, mobile terminals such as smartphones or tablet type terminals have been proliferated. The number of decoders mounted on a mobile terminal is 1 and the number of encoded streams of image files such as moving image files simultaneously reproducible on the mobile terminal is 1.

Accordingly, as a method of simultaneously reproducing a plurality of encoded streams on a mobile terminal, a method of re-encoding a plurality of encoded streams with restriction in advance in a multi-stream (combined stream) which is one encoded stream and reproducing the multi-stream has been devised (for example, see “H.264/AVC Prediction Restriction Encoding Control for Fast Multiple Stream Joiner” by Uchihara N. and Kasai H. in Consumer Electronics (ICCE), July, 2012, pp 13-16).

### SUMMARY

In the method disclosed in “H.264/AVC Prediction Restriction Encoding Control for Fast Multiple Stream Joiner” by Uchihara N. and Kasai H. in Consumer Electronics (ICCE), July 2012, pp 13-16 however, an image decoded by a mobile terminal is assumed to be displayed without change. Accordingly, a technology for generating the multi-stream according to a method suitable when the mobile terminal performs a predetermined process after the decoding and then displays an image has not been considered.

It is desirable to provide a technology for generating a combined stream according to a method suitable when a process is performed after decoding of the combined stream.

According to an embodiment of the present technology, there is provided an image processing device including a generation unit configured to generate a combined stream, which is one encoded stream of a plurality of images generated from encoded streams of the plurality of images, from the encoded streams of the plurality of images according to a method corresponding to a process performed after decoding of the combined stream.

An image processing method and a program according to an embodiment of the present technology correspond to an image processing device according to an embodiment of the present technology.

According to an embodiment of the present technology, the combined stream is generated from the encoded streams of the plurality of images according to the method corresponding to the process after the combined stream, which is one encoded stream of the plurality of images generated from the encoded streams of the plurality of images, is decoded.

According to an embodiment of the present technology, the combined stream can be generated according to a method suitable when the process is performed after the decoding of the combined stream.

### BRIEF DESCRIPTION OF THE DRAWINGS

FIG. 1 is a block diagram illustrating an example of the configuration of an image processing system including a first embodiment of an image processing device to which the present technology is applied;

FIG. 2 is a block diagram illustrating an example of the configuration of the image processing device in FIG. 1;

FIG. 3 is a diagram illustrating an example of the structure of a multi-stream;

FIGS. 4A and 4B are diagrams illustrating examples of decoded results of the multi-stream;

FIG. 5 is a flowchart for describing a generation process of the image processing device in FIG. 2;

FIG. 6 is a flowchart for describing the details of a criterion process of FIG. 5;

FIG. 7 is a flowchart for describing the details of a non-criterion process of FIG. 5;

FIG. 8 is a flowchart illustrating the details of an output process of FIG. 5;

FIG. 9 is a block diagram illustrating an example of the configuration of an image processing system including a second embodiment of an image processing device to which the present technology is applied;

FIG. 10 is a block diagram illustrating an example of the configuration of the image processing device in FIG. 9;

FIG. 11 is a diagram illustrating reference picture change information in the multi-stream;

FIG. 12 is a diagram illustrating an example of the structure of a multi-stream;

FIGS. 13A and 13B are diagrams illustrating examples of decoded results of the multi-stream;

FIG. 14 is a flowchart for describing the details of a criterion process;

FIG. 15 is a flowchart for describing the details of a non-criterion process;

FIG. 16 is a flowchart illustrating the details of an output process;

FIG. 17 is a block diagram illustrating an example of the configuration of an image processing system including a third embodiment of an image processing device to which the present technology is applied;

FIG. 18 are diagrams illustrating restriction at the time of encoding of image data of dummy images;

FIG. 19 is a block diagram illustrating an example of the configuration of the image processing device in FIG. 17;

FIG. 20 is a diagram illustrating an example of the structure of a multi-stream;

FIGS. 21A and 21B are diagrams illustrating examples of decoded results of the multi-stream;

FIG. 22 is a flowchart for describing a generation process of the image processing device in FIG. 19;

FIG. 23 is a flowchart for describing the details of a criterion process of FIG. 22;

FIG. 24 is a flowchart for describing the details of a non-criterion process of FIG. 22;

FIG. 25 is a flowchart illustrating the details of an output process of FIG. 22;

FIG. 26 is a block diagram illustrating an example of the configuration of an image processing system including a fourth embodiment of an image processing device to which the present technology is applied;

FIG. 27 is a block diagram illustrating an example of the configuration of the image processing device in FIG. 26;

FIG. 28 is a diagram illustrating an example of the structure of a multi-stream;

FIG. 29 is a diagram illustrating an example of a decoded result of the multi-stream;

FIG. 30 is a flowchart for describing a generation process of the image processing device in FIG. 26;

FIG. 31 is a flowchart for describing the details of a criterion process of FIG. 30;

FIG. 32 is a flowchart for describing the details of a second non-criterion process of FIG. 30;

FIG. 33 is a flowchart illustrating the details of an output process of FIG. 30; and

FIG. 34 is a block diagram illustrating an example of a hardware configuration of a computer.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### <Example of Configuration of Image Processing System Including First Embodiment of Image Processing Device>

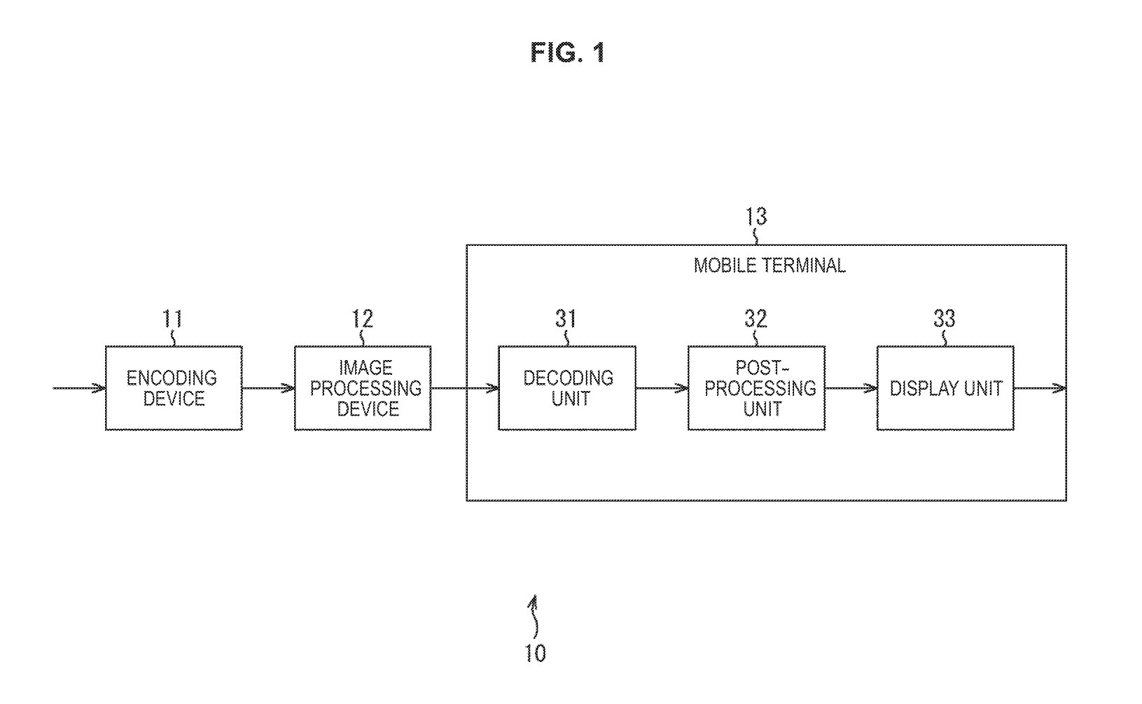

FIG. 1 is a block diagram illustrating an example of the configuration of an image processing system including a first embodiment of an image processing device to which the present technology is applied.

An image processing system 10 in FIG. 1 includes an encoding device 11, an image processing device 12, and a mobile terminal 13. The image processing system 10 generates a multi-stream from encoded streams of a plurality of image files, performs a process of dividing a decoded result of the multi-stream in a vertical direction, and then displays the divided result.

Specifically, the encoding device 11 of the image processing system 10 encodes image data of a plurality of image files (two image files in the first embodiment) input from the outside for each image file in conformity with an advance video coding (AVC) scheme under a predetermined restriction. For example, the predetermined restriction is that a sequence parameter set (SPS) and a picture parameter set (PPS) of image data of each image file be the same and a bit length of syntax be set to a bit length in which an emulation prevention byte is not generated at the time of generation of a multi-stream. The encoding device 11 supplies the encoded streams of the plurality of image files obtained as an encoding result of the image processing device 12.

The image processing device 12 functions as a generation unit to generate one encoded stream as a multi-stream from the encoded streams of the plurality of image files supplied from the encoding device 11. Specifically, the image processing device 12 multiplexes the encoded image data (hereinafter referred to as encoded data) included in each of the encoded streams of the plurality of image files in the vertical direction to generate the multi-stream. The image processing device 12 supplies the multi-stream to the mobile terminal 13.

The mobile terminal 13 includes a decoding unit 31, a post-processing unit 32, and a display unit 33.

The decoding unit 31 of the mobile terminal 13 decodes the multi-stream supplied from the image processing device 12 to generate image data of the plurality of image files. The decoding unit 31 supplies the generated image data of the plurality of image files to the post-processing unit 32.

The post-processing unit 32 divides the image data of the plurality of image files supplied from the decoding unit 31 in the vertical direction and supplies the divided image data as image data of each image file to the display unit 33.

The display unit 33 displays an image of each image file based on the image data of each image file supplied from the post-processing unit 32.

As described above, the image processing device 12 generates one multi-stream from the encoded streams of the plurality of image files. Accordingly, the mobile terminal 13 can reproduce the image data of the plurality of image files with a low load by decoding one multi-stream.

### <Example of Configuration of Image Processing Device>

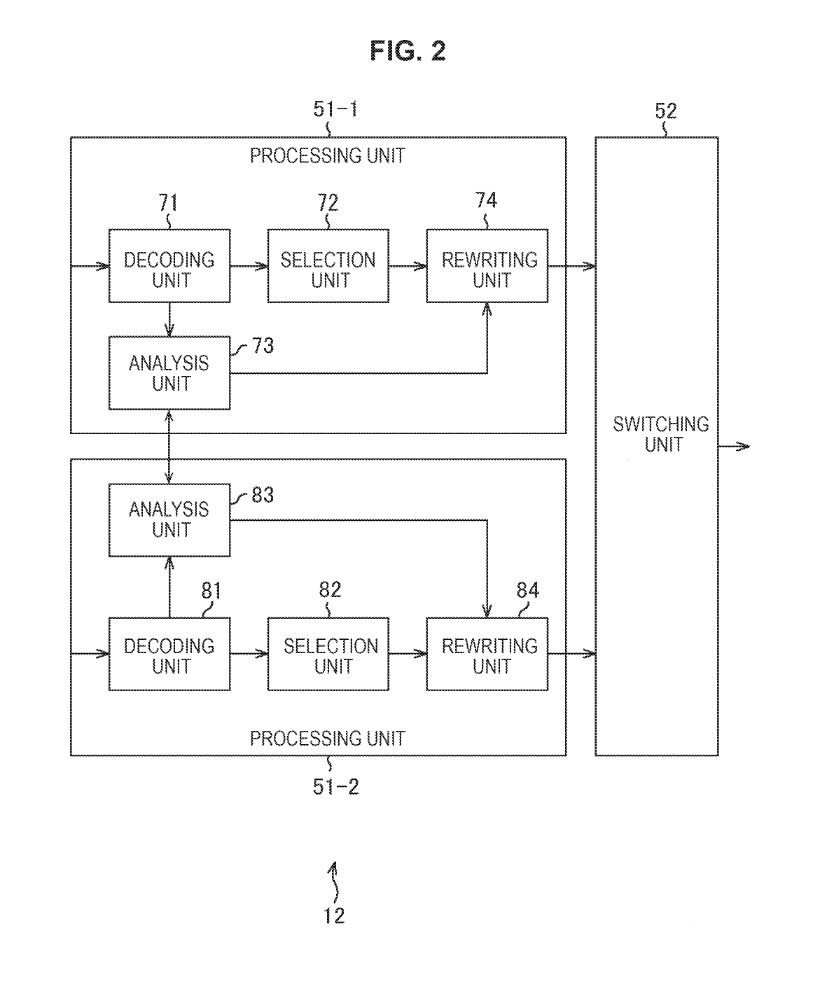

FIG. 2 is a block diagram illustrating an example of the configuration of the image processing device 12 in FIG. 1.

The image processing device 12 in FIG. 2 includes a processing unit 51-1, a processing unit 51-2, and a switching unit 52.

The processing unit 51-1 of the image processing device 12 includes a decoding unit 71, a selection unit 72, an analysis unit 73, and a rewriting unit 74 and generates data included in the multi-stream based on one encoded stream serving as a criterion stream.

Specifically, the decoding unit 71 of the processing unit 51-1 acquires the one encoded stream supplied from the encoding device 11 in FIG. 1 as a criterion stream. The decoding unit 71 decodes the criterion stream to extract an SPS, a PPS, encoded data (hereinafter referred to as slice data) in slice units, and a delimiter indicating termination of data in picture units included in the criterion stream. The decoding unit 71 supplies the extracted SPS, PPS, slice data, and delimiter to the selection unit 72 and supplies the slice data to the analysis unit 73.

The selection unit 72 selects the SPS, the PPS, the slice data, and the delimiter supplied from the decoding unit 71 as valid data used to generate the multi-stream and supplies the SPS, the PPS, the slice data, and the delimiter to the rewriting unit 74.

The analysis unit 73 extracts a header portion (hereinafter referred to as a slice header) between a data portion and the header portion that form the slice data supplied from the decoding unit 71. The analysis unit 73 analyzes the slice header to acquire a frame number (frame_num) and Picture Order Count (POC) information (pic_order_cnt_lsb) included in the slice header.

The frame number refers to information used to identify a corresponding slice frame and the POC information refers to information used to calculate the POC of a picture of a corresponding slice.

The analysis unit 73 acquires the frame number and the POC information of a non-criterion stream, which are encoded streams used to generate the multi-stream in addition to the criterion stream, from the processing unit 51-2. The analysis unit 73 determines a common frame number common to the criterion stream and the non-criterion stream based on the frame numbers of the criterion stream and the non-criterion stream and supplies the common frame number to the rewriting unit 74. Likewise, the analysis unit 73 determines common POC information and supplies the common POC information to the rewriting unit 74. The analysis unit 73 supplies the common frame number and the common POC information to an analysis unit 83.

The rewriting unit 74 supplies the SPS, the PPS, and the delimiter supplied from the selection unit 72 to the switching unit 52 without change. The rewriting unit 74 rewrites the frame number and the POC information included in the slice header of the slice data supplied from the selection unit 72 with the common frame number and the common POC information supplied from the analysis unit 73.

Through the rewriting, the bit length of the syntax is changed. However, the restriction that when the criterion stream is generated, the bit length of the syntax be set to a bit length in which an emulation prevention byte is not generated at the time of generation of a multi-stream is imposed. Therefore, the emulation prevention byte is not generated. The rewriting unit 74 supplies the rewritten slice data to the switching unit 52.

The processing unit 51-2 includes a decoding unit 81, a selection unit 82, an analysis unit 83, and a rewriting unit 84 and generates data included in the multi-stream based on the non-criterion stream.

Specifically, the decoding unit 81 of the processing unit 51-2 acquires the one encoded stream supplied from the encoding device 11 in FIG. 1 as a non-criterion stream. The decoding unit 81 decodes the non-criterion stream to extract an SPS, a PPS, slice data, and a delimiter included in the non-criterion stream. The decoding unit 81 supplies the extracted SPS, PPS, slice data, and delimiter to the selection unit 82 and supplies the slice data to the analysis unit 83.

The selection unit 82 selects the slice data as valid data among the SPS, the PPS, the slice data, and the delimiter supplied from the decoding unit 81 and supplies the selected slice data to the rewriting unit 84.

The analysis unit 83 extracts a slice header from the slice data supplied from the decoding unit 81. The analysis unit 83 analyzes the slice header to acquire a frame number, POC information, and head macro information (first_mb_in_slice) included in the slice header. The head macro information refers to information that indicates the address of a head macro block of a corresponding slice.

The analysis unit 83 supplies the frame number and the POC information to the analysis unit 73 of the processing unit 51-1 and accordingly acquires a common frame number and common POC information from the analysis unit 73. The analysis unit 83 determines head macro information in the multi-stream based on the head macro information or the like of the non-criterion stream. The analysis unit 83 supplies the common frame number, the common POC information, and the head macro information in the multi-stream to the rewriting unit 84.

The rewriting unit 84 rewrites the frame number, the POC information, and the head macro information included in the slice header of the slice data supplied as the valid data from the selection unit 82 with the common frame number, the common POC information, and the head macro information supplied from the analysis unit 83.

The emulation prevention byte is not generated in the rewriting for the same reason as in the case of the rewriting unit 74. The rewriting unit 84 supplies the rewritten slice data to the switching unit 52.

The switching unit 52 outputs the SPS, the PPS, and the slice data supplied from the rewriting unit 74 as the multi-stream in order, and then outputs the slice data supplied from the rewriting unit 84 as the multi-stream. Further, the switching unit 52 outputs the delimiter supplied from the rewriting unit 74 as the multi-stream.

### <Example of Configuration of Multi-Stream>

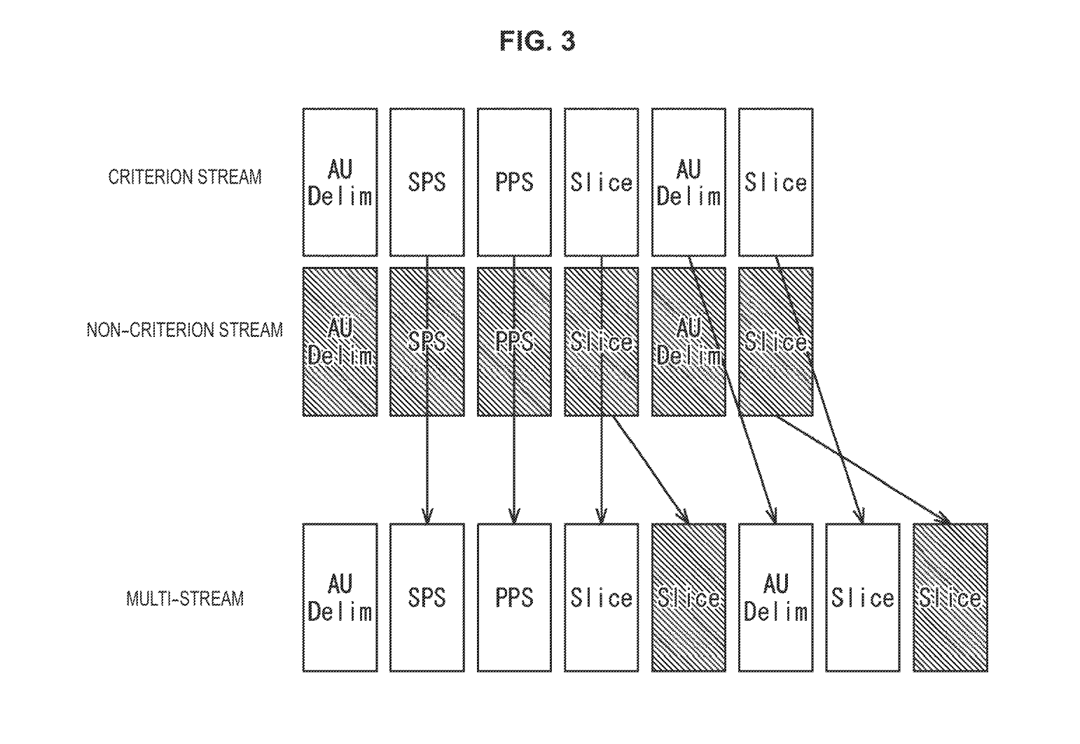

FIG. 3 is a diagram illustrating an example of the configuration of the multi-stream.

As illustrated in FIG. 3, the criterion stream and the non-criterion stream each include the SPS, the PPS, the slice data (Slice), and the delimiter.

The multi-stream includes the SPS, the PPS, and the delimiter included in the criterion stream and also includes the slice data included in the criterion stream and the non-criterion stream in which the slice header is rewritten. That is, the multi-stream is configured such that the slice data included in the criterion stream and the non-criterion stream is slice data of one picture. Thus, the multi-stream is an encoded stream in which pictures are configured from the slice of the criterion stream and the slice of the non-criterion stream.

In the first embodiment, the SPS and the PPS of the criterion stream are used without change as the SPS and the PPS of the multi-stream, but may be updated and used, as necessary.

### <Example of Decoded Result of Multi-Stream>

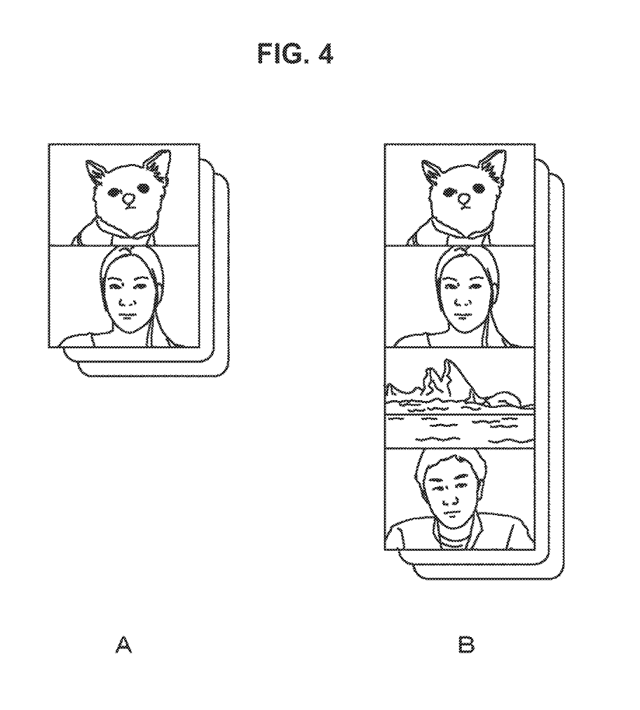

FIGS. 4A and 4B are diagrams illustrating examples of decoded results of the multi-stream.

As described above, the multi-stream is the encoded stream in which a picture is configured from the slice of the criterion stream and the slice of the non-criterion stream. Accordingly, when the multi-stream is decoded, as illustrated in FIG. 4A, images in which an image corresponding to the criterion stream and an image corresponding to the non-criterion stream are multiplexed in the vertical direction are generated.

Likewise, for example, when a multi-stream is generated from encoded streams of four image files, as illustrated in FIG. 4B, images for which an image corresponding to the criterion stream and images corresponding to three non-criterion streams are multiplexed in the vertical direction are generated.

### <Description of Process of Image Processing Device>

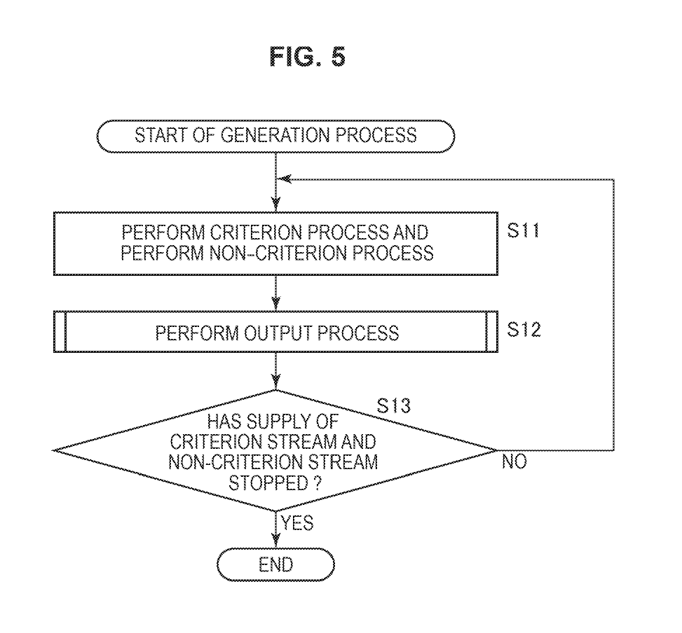

FIG. 5 is a flowchart for describing a generation process of the image processing device 12 in FIG. 2. The generation process starts when supply of the criterion stream and the non-criterion stream from the encoding device 11 starts.

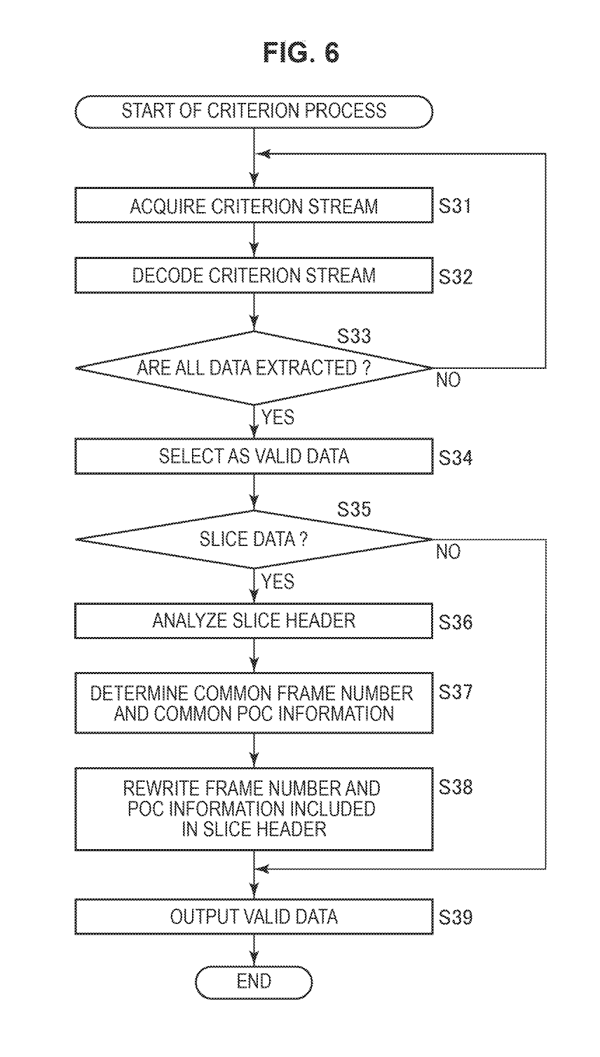

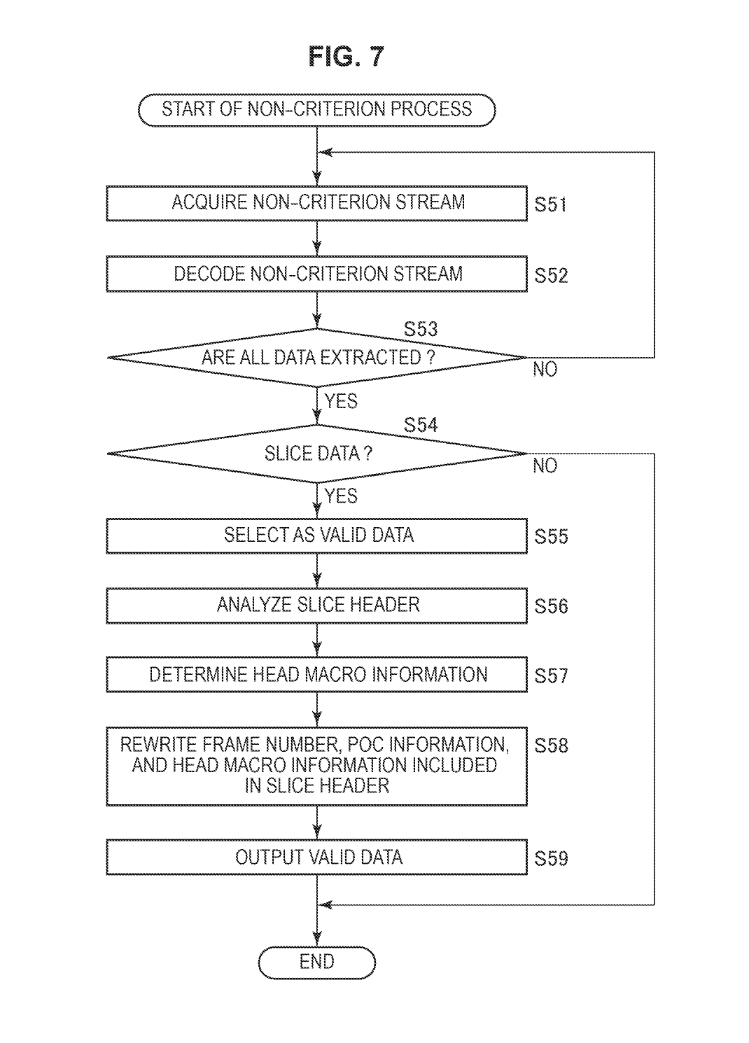

In step S11 of FIG. 5, the processing unit 51-1 performs a criterion process of generating a part of the multi-stream from the criterion stream and the processing unit 51-2 performs a non-criterion process of generating a part of the multi-stream from the criterion stream. The details of the criterion process will be described below with reference to FIG. 6. The details of the non-criterion process will be described below with reference to FIG. 7.

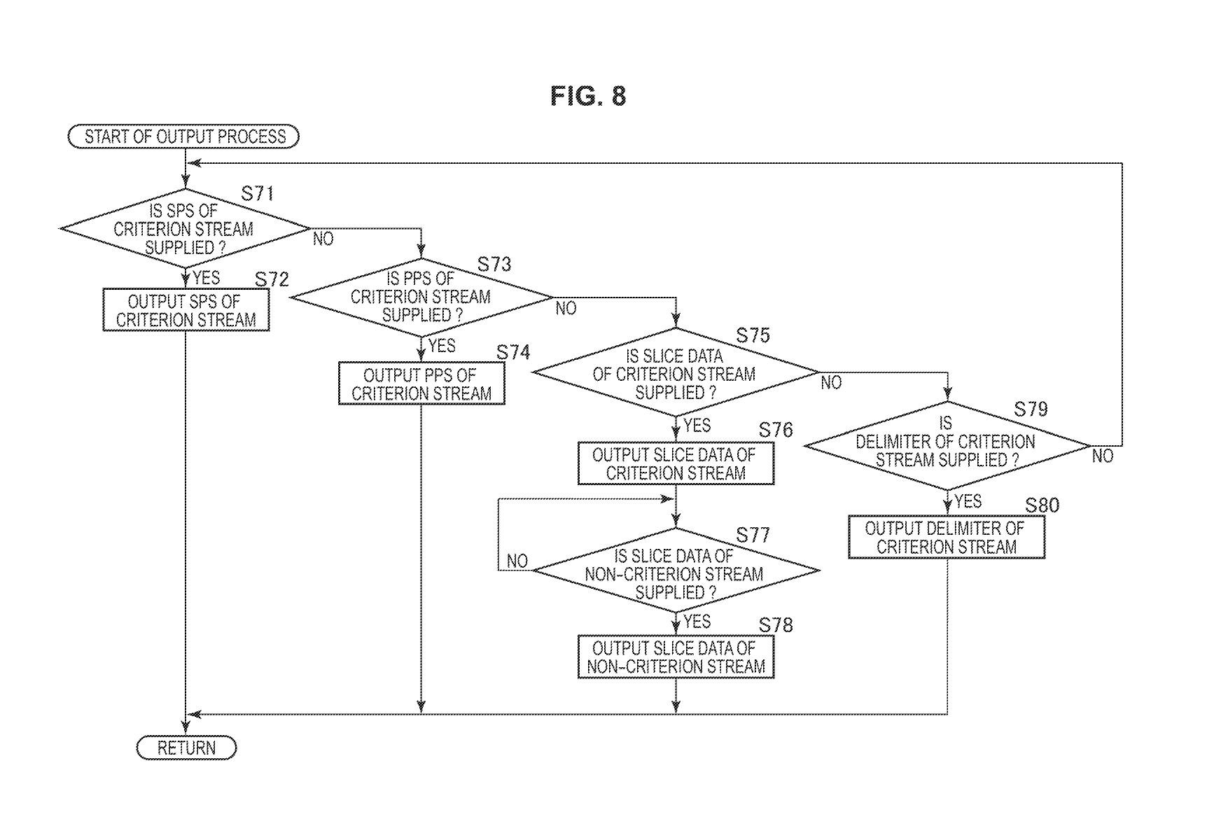

In step S12, the switching unit 52 performs an output process of outputting the SPS, the PPS, the slice data, and the delimiter supplied from the processing unit 51-1 and the slice data supplied from the processing unit 51-2 in order. The details of the output process will be described below with reference to FIG. 8.

In step S13, the switching unit 52 determines whether supply of the criterion stream and the non-criterion stream has stopped. When supply of the criterion stream and the non-criterion stream has not stopped in step S13, the process returns to step S11 and the processes of step S11 to step S13 are repeated.

Conversely, when it is determined in step S13 that supply of the criterion stream and the non-criterion stream has stopped, the process ends.

FIG. 6 is a flowchart for describing the details of the criterion process in step S11 of FIG. 5.

In step S31 of FIG. 6, the decoding unit 71 of the processing unit 51-1 acquires the criterion stream supplied from the encoding device 11.

In step S32, the decoding unit 71 decodes the criterion stream to extract any one of the SPS, the PPS, the slice data, and the delimiter included in the criterion stream. The decoding unit 71 supplies any one of the extracted SPS, PPS, slice data, and delimiter to the selection unit 72.

In step S33, the decoding unit 71 determines whether all of the data of the SPS, the PPS, the slice data, and the delimiter is extracted in step S32. When it is determined in step S33 that not all of the data is extracted yet, the process returns to step S31 and the processes of step S31 to step S33 are repeated until all of the data is extracted.

Conversely, when it is determined in step S33 that all of the data is extracted, the process proceeds to step S34. In step S34, the selection unit 72 selects all of the data of the SPS, the PPS, the encoded data, and the delimiter supplied from the decoding unit 71 as the valid data and supplies the SPS, the PPS, the slice data, and the delimiter to the rewriting unit 74.

In step S35, the decoding unit 71 determines whether the data extracted in step S32 is the slice data. When the decoding unit 71 determines in step S35 that the data extracted in step S32 is the slice data, the decoding unit 71 supplies the slice data to the analysis unit 73 and the process proceeds to step S36.

In step S36, the analysis unit 73 analyzes the slice header included in the slice data supplied from the decoding unit 71 to acquire the frame number and the POC information included in the slice header. The analysis unit 73 also acquires the frame number and the POC information of the non-criterion stream from the analysis unit 83 of the processing unit 51-2.

In step S37, the analysis unit 73 determines the common frame number common to the criterion stream and the non-criterion stream based on the frame numbers of the criterion stream and the non-criterion stream. The analysis unit 73 determines the common POC information common to the criterion stream and the non-criterion stream based on the POC information of the criterion stream and the non-criterion stream. The analysis unit 83 supplies the common frame number and the common POC information to the rewriting unit 74 and the processing unit 51-2.

In step S38, the rewriting unit 74 rewrites the frame number and the POC information included in the slice header of the slice data supplied from the selection unit 72 with the common frame number and the common POC information supplied from the analysis unit 73. Then, the process proceeds to step S39.

Conversely, when it is determined in step S35 that the data extracted in step S32 is not the slice data, the process proceeds to step S39.

In step S39, the rewriting unit 74 outputs the SPS, the PPS, or the delimiter as the valid data supplied from the selection unit 72 or the slice data rewritten in step S38 to the switching unit 52.

FIG. 7 is a flowchart for describing the details of the non-criterion process in step S11 of FIG. 5.

In step S51 of FIG. 7, the decoding unit 81 of the processing unit 51-2 acquires the non-criterion stream supplied from the encoding device 11. In step S52, the decoding unit 81 decodes the non-criterion stream to extract any one of the SPS, the PPS, the slice data, and the delimiter included in the non-criterion stream. The decoding unit 81 supplies any one of the extracted SPS, PPS, slice data, and delimiter to the selection unit 82. When the slice data is extracted, the decoding unit 81 supplies the extracted slice data to the analysis unit 83.

In step S53, the decoding unit 81 determines whether all of the data of the SPS, the PPS, the slice data, and the delimiter is extracted in step S52. When it is determined in step S53 that not all of the data is extracted yet, the process returns to step S51 and the processes of step S51 to step S53 are repeated until all of the data is extracted.

Conversely, when it is determined in step S53 that all of the data is extracted, the selection unit 82 determines in step S54 whether the data supplied from the decoding unit 81 is the slice data.

When it is determined in step S54 that the data supplied from the decoding unit 81 is the slice data, the selection unit 82 selects the slice data as the valid data in step S55 and supplies the slice data to the rewriting unit 84.

In step S56, the analysis unit 83 analyzes the slice header included in the slice data supplied from the decoding unit 81 to acquire the frame number, the POC information, and the head macro information included in the slice header. The analysis unit 83 supplies the frame number and the POC information to the analysis unit 73 of the processing unit 51-1 and accordingly acquires the common frame number and the common POC information from the analysis unit 73.

In step S57, the analysis unit 83 determines the head macro information in the multi-stream based on the head macro information of the non-criterion stream. The analysis unit 83 supplies the common frame number, the common POC information, and the head macro information in the multi-stream to the rewriting unit 84.

In step S58, the rewriting unit 84 rewrites the frame number, the POC information, and the head macro information included in the slice header of the slice data from the selection unit 82 with the common frame number, the common POC information, and the head macro information supplied from the analysis unit 83. In step S59, the rewriting unit 84 outputs the rewritten slice data as the valid data to the switching unit 52. Then, the process ends.

Conversely, when it is determined in step S54 that the data supplied from the decoding unit 81 is not the slice data, the process ends.

FIG. 8 is a flowchart for describing the details of the output process in step S12 of FIG. 5.

In step S71 of FIG. 8, the switching unit 52 determines whether the SPS of the criterion stream is supplied from the rewriting unit 74. When the switching unit 52 determines in step S71 that the SPS of the criterion stream is supplied, the switching unit 52 outputs the SPS of the criterion stream as the multi-stream in step S72. Then, the process returns to step S12 of FIG. 5 and proceeds to step S13.

Conversely, when the switching unit 52 determines in step S71 that the SPS of the criterion stream is not supplied, the switching unit 52 determines in step S73 whether the PPS of the criterion stream is supplied from the rewriting unit 74.

When the switching unit 52 determines in step S73 that the PPS of the criterion stream is supplied, the switching unit 52 outputs the PPS of the criterion stream as the multi-stream in step S74. Then, the process returns to step S12 and proceeds to step S13.

Conversely, when the switching unit 52 determines in step S73 that the PPS of the criterion stream is not supplied, the switching unit 52 determines in step S75 whether the slice data of the criterion stream is supplied from the rewriting unit 74.

When the switching unit 52 determines in step S75 that the slice data of the criterion stream is supplied, the switching unit 52 outputs the slice data of the criterion stream as the multi-stream in step S76. In step S77, the switching unit 52 determines whether the slice data of the non-criterion stream is supplied from the rewriting unit 84.

When the switching unit 52 determines in step S77 that the slice data of the non-criterion stream is not supplied, the switching unit 52 waits until the slice data of the non-criterion stream is supplied. Conversely, when the switching unit 52 determines in step S77 that the slice data of the non-criterion stream is supplied, the switching unit 52 outputs the slice data of the non-criterion stream as the multi-stream in step S78. Then, the process returns to step S12 and proceeds to step S13.

Conversely, when the switching unit 52 determines in step S75 that the slice header of the criterion stream is not supplied, the switching unit 52 determines in step S79 whether the delimiter of the criterion stream is supplied from the rewriting unit 74.

When the switching unit 52 determines in step S79 that the delimiter of the criterion stream is supplied, the switching unit 52 outputs the delimiter of the criterion stream as the multi-stream in step S80. Then, the process returns to step S12 and proceeds to step S13.

Conversely, when it is determined in step S79 that the delimiter of the criterion stream is not supplied, the process returns to step S71 and the subsequent processes are repeated.

As described above, the image processing device 12 generates the multi-stream according to the method of multiplexing the slice data included in the criterion stream and the non-criterion stream in the vertical direction as a method corresponding to the process of dividing the image data of the plurality of image files obtained as the decoding result of the multi-stream in the vertical direction to form the image data of each image file. Thus, the multi-stream can be generated by merely rewriting the slice headers of the criterion stream and the non-criterion stream.

On the other hand, when the mobile terminal displays image data of a plurality of image files obtained as the decoding result of a multi-stream without performing any process on the image data, the mobile terminal displays images which are obtained by multiplexing images of a criterion stream and a non-criterion stream in the vertical direction. However, since this display is not generally used, the method of generating the multi-stream in the image processing device 12 is not suitable in this case.

Since the image processing device 12 multiplexes the slice data of the criterion stream and the non-criterion stream in the vertical direction, the restriction at the time of the encoding of the criterion stream and the non-criterion stream is less imposed. When the criterion stream and the non-criterion stream are encoded, it is not necessary to impose restriction of a prediction mode.

In the first embodiment, the restriction that the SPSs and the PPSs of the criterion stream and the non-criterion stream be the same has been imposed as the restriction at the time of the encoding. However, in the AVC standard, since each slice can refer to other SPS and PPS, this restriction may not be imposed. In this case, the SPSs and the PPSs of both of the criterion stream and the non-criterion stream are included in the multi-stream.

However, when the above-described restriction that the SPSs and the PPSs of the criterion stream and the non-criterion stream be the same is imposed, initialization based on the SPSs and the PPSs can be commonly performed at the time of decoding of the multi-stream, thereby reducing the load of the decoding process.

### Second Embodiment

<Example of Configuration of Image Processing System Including Second Embodiment of image Processing Device>

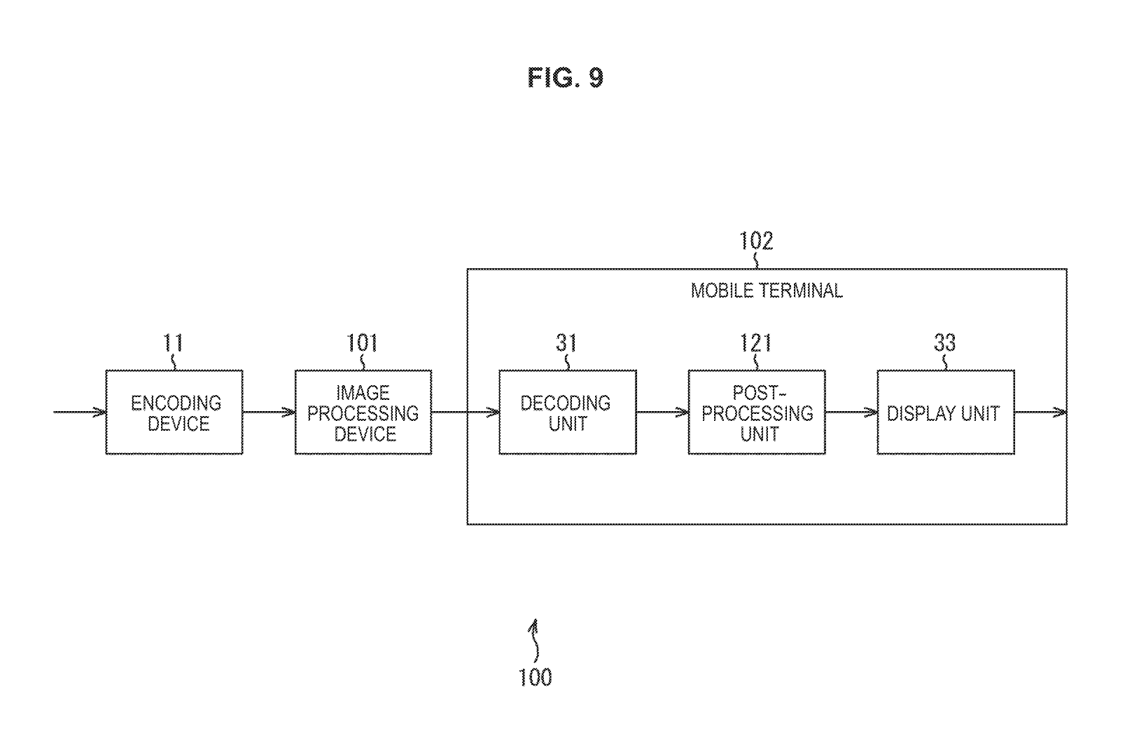

FIG. 9 is a block diagram illustrating an example of the configuration of an image processing system including a second embodiment of an image processing device to which the present technology is applied.

The same reference numerals are given to constituent elements having the same configuration as the configuration in FIG. 1 among constituent elements illustrated in FIG. 9. The repeated description will be appropriately omitted.

The configuration of an image processing system 100 in FIG. 9 is different from the configuration of the image processing system 10 in FIG. 1 in that an image processing device 101 is provided instead of the image processing device 12 and the mobile terminal 102 is provided instead of the mobile terminal 13. The image processing system 100 generates a multi-stream from encoded streams of a plurality of image files, performs a process of dividing a decoded result of the multi-stream in a time direction, and then displays the divided result.

Specifically, the image processing device 101 of the image processing system 100 functions as a generation unit and generates a multi-stream from encoded streams of a plurality of image files (two image files in the second embodiment) supplied from the encoding device 11. More specifically, the image processing device 101 multiplexes slice data included in each of the plurality of image files in a time direction to form a multi-stream. The image processing device 101 supplies the multi-stream to the mobile terminal 102.

The configuration of the mobile terminal 102 is different from the configuration of the mobile terminal 13 in FIG. 1 in that a post-processing unit 121 is provided instead of the post-processing unit 32.

The post-processing unit 121 of the mobile terminal 102 divides the image data of the plurality of image files supplied from the decoding unit 31 in the time direction and supplies the divided image data as image data of each image file to the display unit 33.

### <Example of Configuration of Image Processing Device>

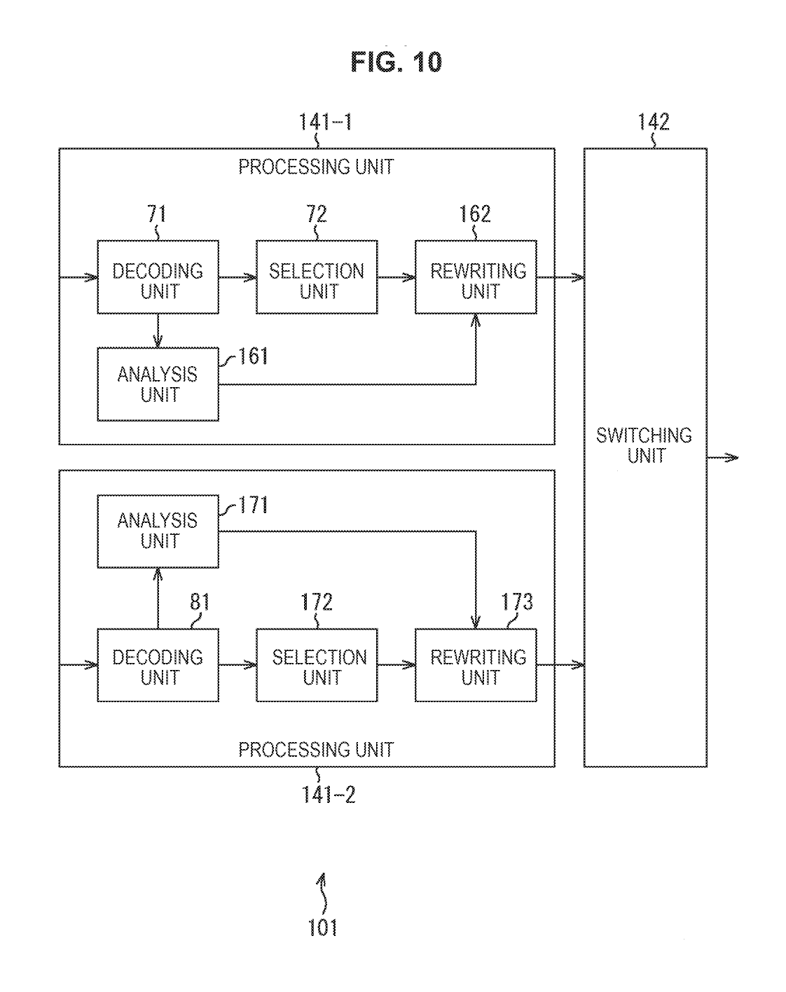

FIG. 10 is a block diagram illustrating an example of the configuration of the image processing device 101 in FIG. 9.

The same reference numerals are given to constituent elements having the same configuration as in FIG. 2 among constituent elements illustrated in FIG. 10. The repeated description will be appropriately omitted.

The image processing device 101 in FIG. 10 includes a processing unit 141-1, a processing unit 141-2, and a switching unit 142.

The configuration of the processing unit 141-1 of the image processing device 101 is different from the configuration of the image processing device 12 in FIG. 2 in that the analysis unit 161 is provided instead of the analysis unit 73 and the rewriting unit 162 is provided instead of the rewriting unit 74.

The analysis unit 161 of the processing unit 141-1 extracts a slice header from slice data supplied from the decoding unit 71. The analysis unit 161 analyzes the slice header and acquires a frame number, POC information, and reference picture change information (ref_pic_list_reordering) included in the slice header.

The reference picture change information refers to information used to specify a reference picture different from a reference picture specified by PPS, as a reference picture of a corresponding slice.

The analysis unit 161 determines a frame number, POC information, and reference picture change information in the multi-stream based on the acquired frame number, POC information, and reference picture change information, the number of encoded streams used in the multi-stream, a reference picture specified by the PPS, and the like. The analysis unit 161 supplies the determined frame number, POC information, and reference picture change information in the multi-stream to the rewriting unit 162.

The rewriting unit 162 supplies the SPS, the PPS, and the delimiter supplied from the selection unit 72 to the switching unit 142 without change. The rewriting unit 162 rewrites the frame number, the POC information, and the reference picture change information included in the slice header of the slice data supplied from the selection unit 72 with the frame number, the POC information, and the reference picture change information in the multi-stream supplied from the analysis unit 161.

Through the rewriting, the bit length of the syntax is changed. However, the restriction that when the criterion stream is generated, the bit length of the syntax be set to a bit length in which an emulation prevention byte is not generated at the time of generation of a multi-stream is imposed. Therefore, the emulation prevention byte is not generated. The rewriting unit 162 supplies the rewritten slice data to the switching unit 142.

The configuration of the processing unit 141-2 is different from the configuration of the processing unit 51-2 in FIG. 2 in that the analysis unit 171 is provided instead of the analysis unit 83, the selection unit 172 is provided instead of the selection unit 82, and the rewriting unit 173 is provided instead of the rewriting unit 84.

The analysis unit 171 of the processing unit 141-2 has the same configuration as the analysis unit 161. That is, the analysis unit 171 extracts and analyzes the slice header from the slice data supplied from the decoding unit 81 to acquire the frame number, the POC information, and the reference picture change information. Then, the analysis unit 171 determines the frame number, the POC information, and the reference picture change information in the multi-stream and supplies the frame number, the POC information, and the reference picture change information to the rewriting unit 173.

The selection unit 172 selects the encoded data and the delimiter as valid data among the SPS, the PPS, the encoded data, and the delimiter supplied from the decoding unit 81 and supplies the encoded data and the delimiter to the rewriting unit 173.

The rewriting unit 173 rewrites the frame number, the POC information, and the reference picture change information included in the slice header of the slice data supplied from the selection unit 172 with the frame number, the POC information, and the reference picture change information in the multi-stream supplied from the analysis unit 171.

The emulation prevention byte is not generated in the rewriting for the same reason as in the case of the rewriting unit 162. The rewriting unit 173 supplies the rewritten slice data to the switching unit 142. The rewriting unit 173 supplies the delimiter supplied from the selection unit 172 without change to the switching unit 142.

The switching unit 142 outputs the SPS, the PPS, the slice data, and the delimiter supplied from the rewriting unit 162 as the multi-stream in order, and then outputs the slice data and the delimiter supplied from the rewriting unit 173 in order as the multi-stream.

### <Description of Reference Picture Change Information in Multi-Stream>

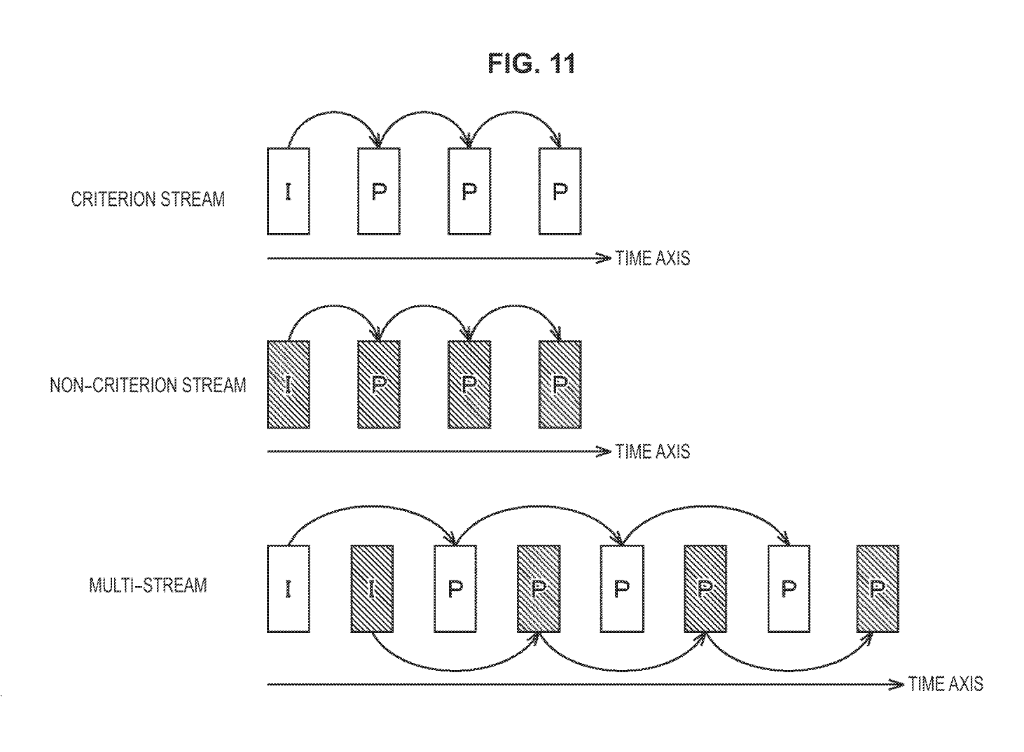

FIG. 11 is a diagram illustrating the reference picture change information in the multi-stream.

Information used to specify the reference picture of the criterion stream included in the PPS or the slice header is information used to specify a picture in the criterion stream. Information used to specify the reference picture of the non-criterion stream is information used to specify a picture in the non-criterion stream.

Accordingly, as illustrated in FIG. 11, when the criterion stream and the non-criterion stream are multiplexed in the time direction to generate the multi-stream, information used to specify a picture in the multi-stream is different from the information used to specify a picture in the criterion stream or the non-criterion stream.

For example, as illustrated in FIG. 11, when a P picture of the criterion stream uses an immediately previous I picture or P picture as a reference picture, the information used to specify the reference picture of the criterion stream is information used to specify an immediately previous picture. However, the information used to specify a picture of the multi-stream is necessarily information used to specify a picture previous to the immediately previous picture. Accordingly, the image processing device 101 changes the information used to specify the reference picture by generating the reference picture change information in the multi-stream.

### <Example of Configuration of Multi-Stream>

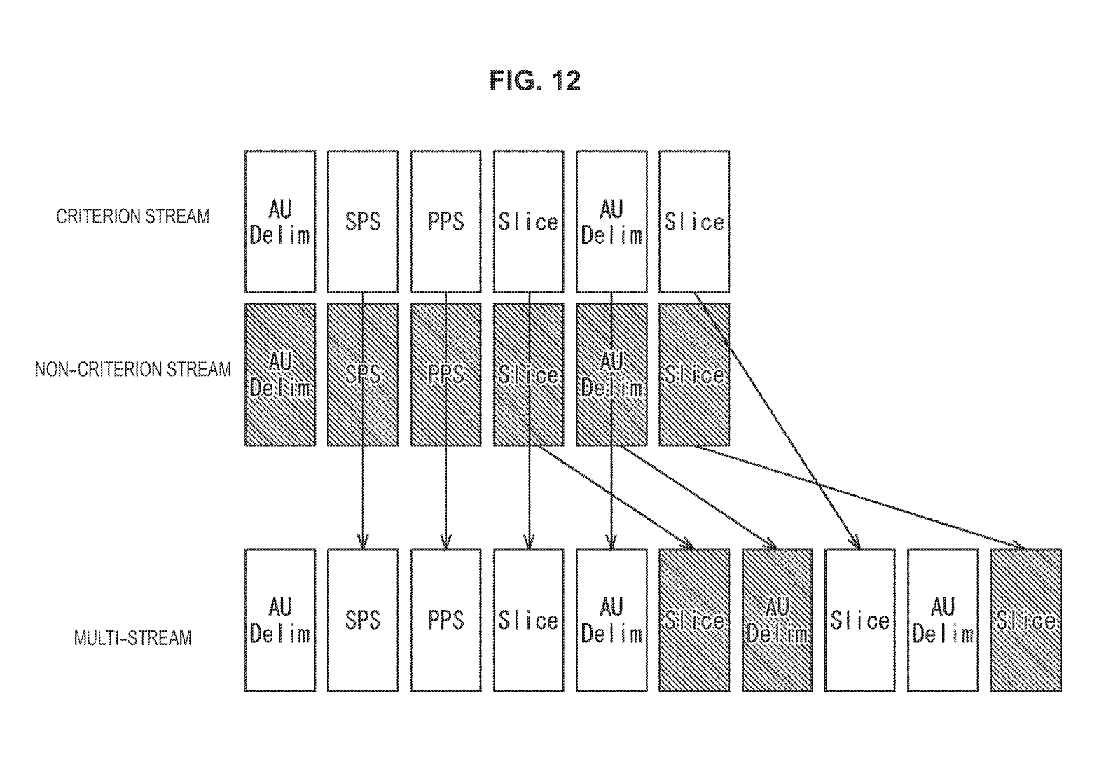

FIG. 12 is a diagram illustrating an example of the configuration of the multi-stream.

As illustrated in FIG. 12, the multi-stream includes the SPS, the PPS, and the delimiter included in the criterion stream, the delimiter included in the non-criterion stream, and the slice data included in the criterion stream and the non-criterion stream in which the slice header is rewritten. Thus, the multi-stream becomes an encoded stream in which pictures formed from the slices of the criterion stream and pictures formed from the slices of the non-criterion stream are alternately disposed.

In the second embodiment, the SPS and the PPS of the criterion stream are used without change as the SPS and the PPS of the multi-stream, but may be updated and used, as necessary.

### <Example of Decoded Result of Multi-Stream>

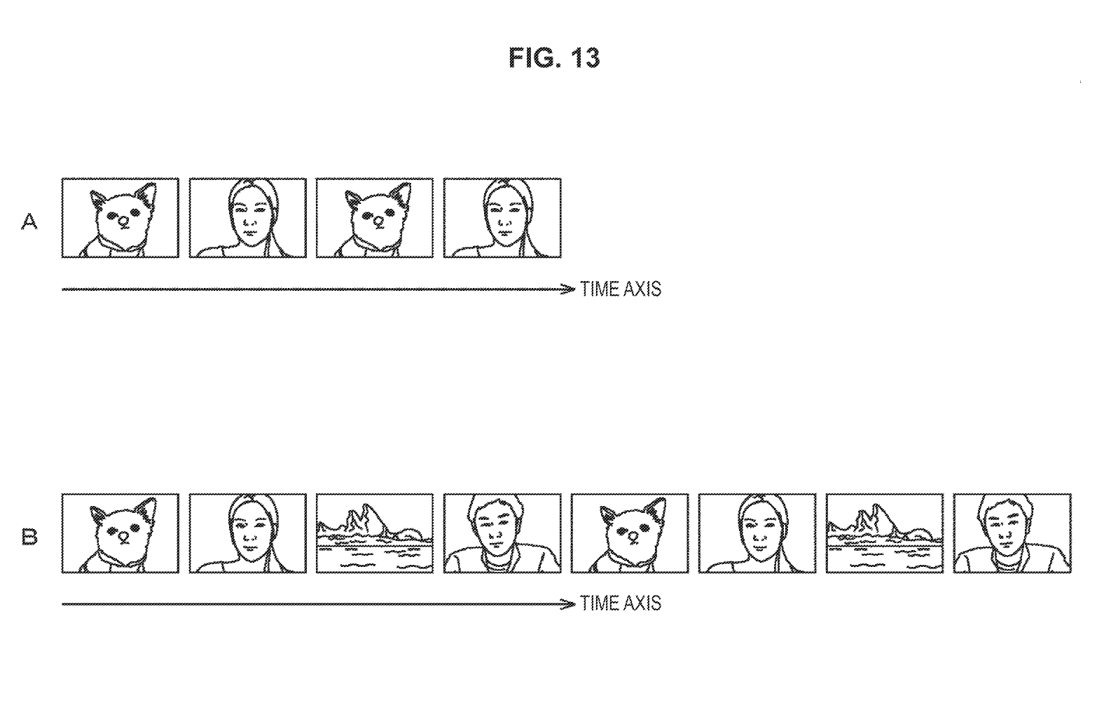

FIGS. 13A and 13B are diagrams illustrating examples of decoded results of the multi-stream.

As described above, the multi-stream is the encoded stream in which the pictures formed from the slices of the criterion stream and the pictures formed from the slices of the non-criterion stream are alternately disposed. Accordingly, when the multi-stream is decoded, as illustrated in FIG. 13A, images in which images corresponding to the criterion stream and an image corresponding to the non-criterion stream are multiplexed in the time direction are generated.

Likewise, for example, when a multi-stream is generated from encoded streams of four image files, as illustrated in FIG. 13B, images for which images corresponding to the criterion stream and images corresponding to three non-criterion streams are multiplexed in the time direction is generated.

### <Description of Process of Image Processing Device>

Since the generation process of the image processing device 101 in FIG. 10 is the same as the generation process in FIG. 5 except for the criterion process and the non-criterion stream in step S11 of FIG. 5 and the output process in step S12, description other than description of these processes will be omitted.

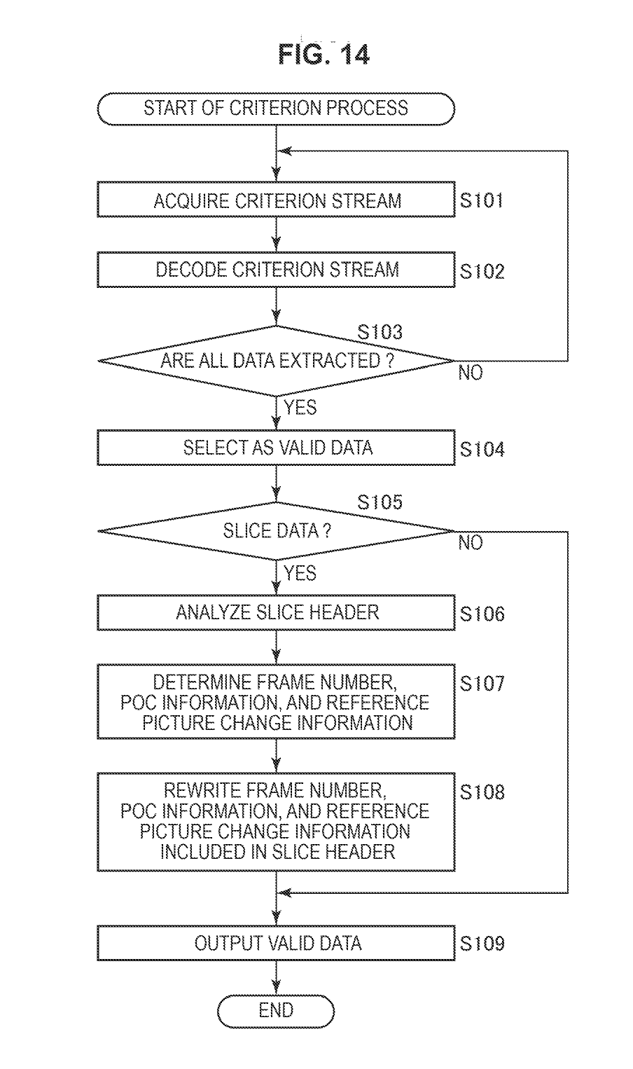

FIG. 14 is a flowchart for describing the details of the criterion process.

Since the processes of step S101 to step S105 of FIG. 14 are the same as the processes of step S31 to step S35 of FIG. 6, the description will be omitted.

In step S106, the analysis unit 161 analyzes the slice header included in the slice data supplied from the decoding unit 71 to acquire the frame number, the POC information, and the reference picture change information included in the slice header.

In step S107, the analysis unit 161 determines the frame number, the POC information, and the reference picture change information in the multi-stream based on the acquired frame number, the acquired POC information, the acquired reference picture change information, the number of encoded streams used in the multi-stream, the reference picture specified by the PPS, and the like. The analysis unit 161 supplies the determined frame number, POC information, and reference picture change information in the multi-stream to the rewriting unit 162.

In step S108, the rewriting unit 162 rewrites the frame number, the POC information, and the reference picture change information included in the slice header of the slice data supplied from the selection unit 72 with the frame number, the POC information, and the reference picture change information in the multi-stream supplied from the analysis unit 161. Then, the process proceeds to step S109.

Conversely, when it is determined in step S105 that the data extracted in step S102 is not the slice data, the process proceeds to step S109.

In step S109, the rewriting unit 162 outputs the SPS, the PPS, or the delimiter as the valid data supplied from the selection unit 72 or the slice data rewritten in step S108 to the switching unit 142.

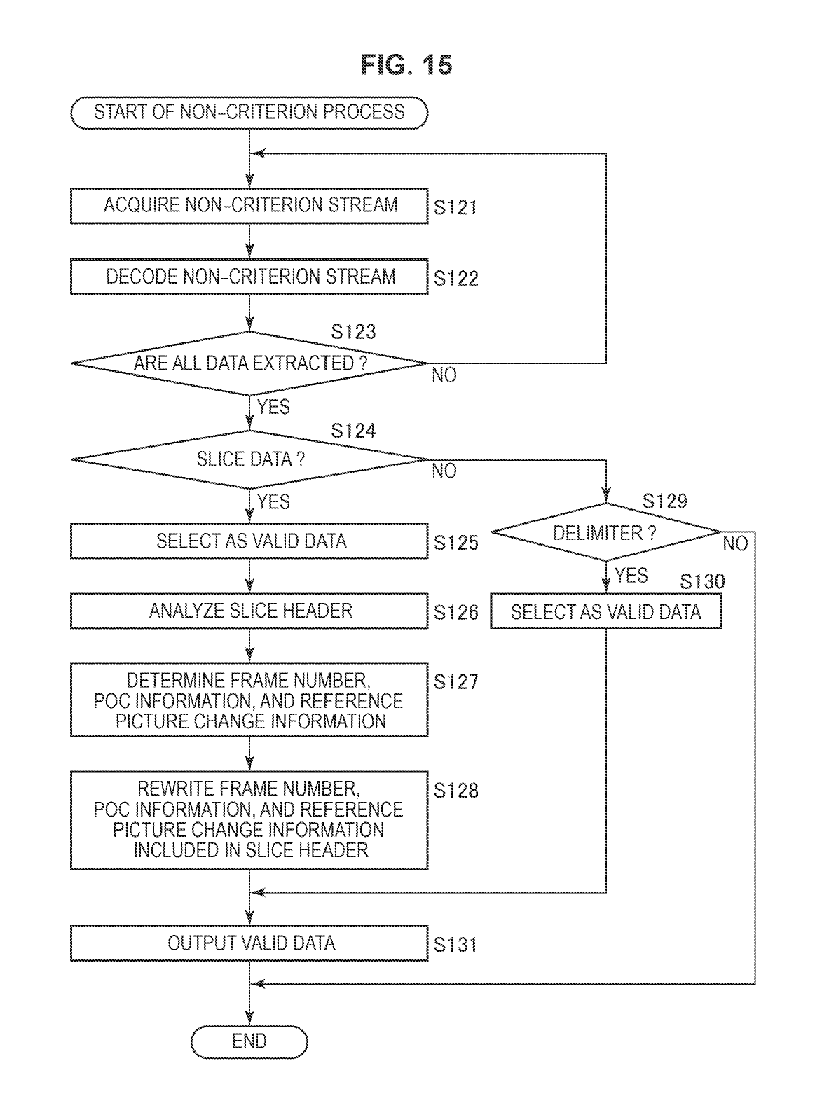

FIG. 15 is a flowchart for describing the details of the non-criterion process.

Since the processes of step S121 to step S125 of FIG. 15 are the same as the processes of step S51 to step S55 of FIG. 7, the description will be omitted.

In step S126, the analysis unit 171 analyzes the slice header included in the slice data supplied from the decoding unit 81 to acquire the frame number, the POC information, and the reference picture change information included in the slice header.

In step S127, as in the analysis unit 161, the analysis unit 171 determines the frame number, the POC information, and the reference picture change information in the multi-stream and supplies the frame number, the POC information, and the reference picture change information to the rewriting unit 173.

In step S128, the rewriting unit 173 rewrites the frame number, the POC information, and the reference picture change information included in the slice header of the slice data supplied from the selection unit 172 with the frame number, the POC information, and the reference picture change information in the multi-stream supplied from the analysis unit 171. Then, the process proceeds to step S131.

Conversely, when it is determined in step S124 that the data supplied from the decoding unit 81 is not the slice data, the selection unit 172 determines in step S129 whether the data supplied from the decoding unit 81 is the delimiter.

When the selection unit 172 determines in step S129 that the data supplied from the decoding unit 81 is the delimiter, the selection unit 172 selects the delimiter as valid data and supplies the delimiter to the rewriting unit 173 in step S130. Then, the process proceeds to step S131.

In step S131, the rewriting unit 173 outputs the slice data rewritten as the valid data or the delimiter supplied from the selection unit 172 to the switching unit 142. Then, the process ends.

Conversely, when it is determined in step S129 that the data supplied from the decoding unit 81 is not the delimiter, the process ends.

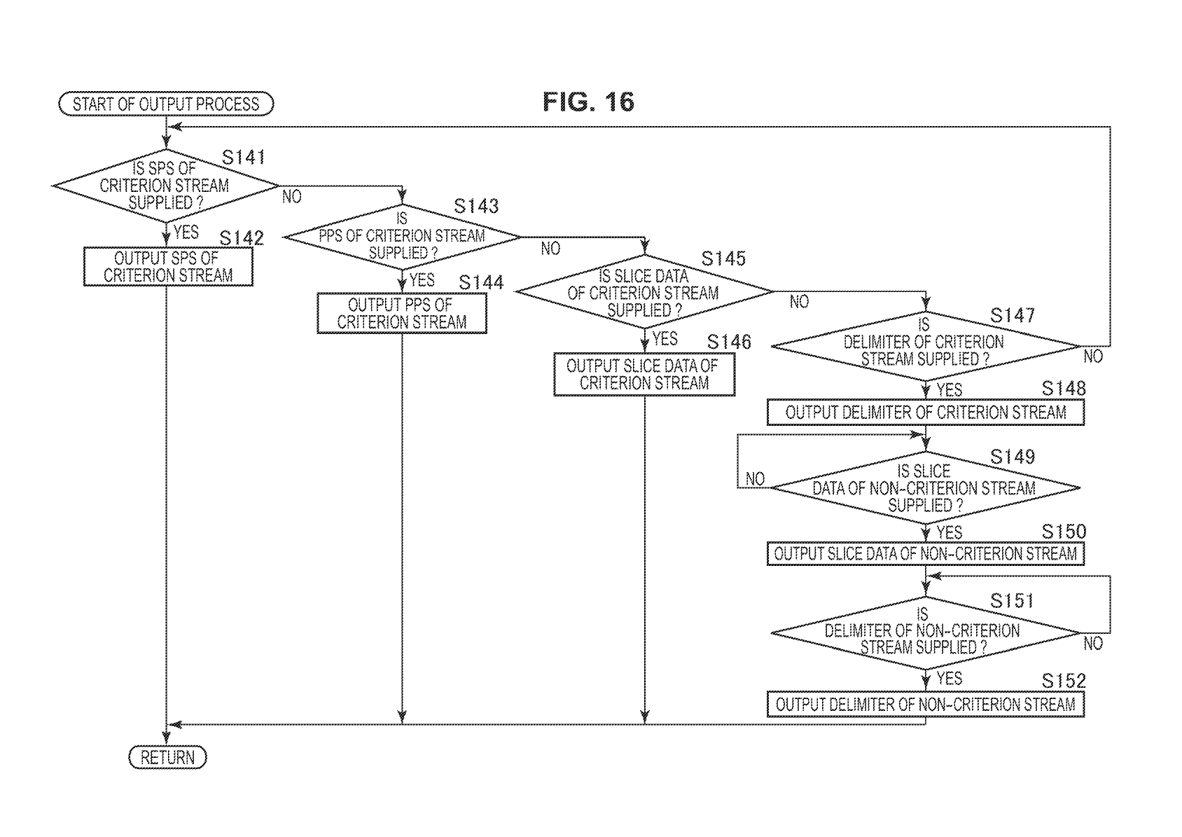

FIG. 16 is a flowchart for describing the details of the output process.

Since the processes of step S141 to step S146 of FIG. 16 are the same as the processes of step S71 to step S76 of FIG. 8, the description will be omitted. After the process of step S146, the output process ends.

When the switching unit 142 determines in step S145 that the slice header of the criterion stream is not supplied, the switching unit 142 determines in step S147 whether the delimiter of the criterion stream is supplied from the rewriting unit 162. When the switching unit 142 determines in step S147 that the delimiter of the criterion stream is supplied, the switching unit 142 outputs the delimiter of the criterion stream as the multi-stream in step S148.

In step S149, the switching unit 52 determines whether the slice data of the non-criterion stream is supplied from the rewriting unit 173. When the switching unit 142 determines in step S149 that the slice data of the non-criterion stream is not supplied, the switching unit 142 waits until the slice data of the non-criterion stream is supplied.

Conversely, when the switching unit 142 determines in step S149 that the slice data of the non-criterion stream is supplied, the switching unit 142 outputs the slice data of the non-criterion stream as the multi-stream in step S150.

In step S151, the switching unit 142 determines whether the delimiter of the non-criterion stream is supplied from the rewriting unit 173. When the switching unit 142 determines in step S151 that the delimiter of the non-criterion stream is not supplied, the switching unit 142 waits until the delimiter of the non-criterion stream is supplied.

Conversely, when the switching unit 142 determines in step S151 that the delimiter of the non-criterion stream is supplied, the switching unit 142 outputs the delimiter of the non-criterion stream as the multi-stream in step S152. Then, the output process ends.

Conversely, when it is determined in step S147 that the delimiter of the criterion stream is not supplied, the process returns to step S141 and the subsequent processes are repeated.

As described above, the image processing device 101 generates the multi-stream according to the method of multiplexing the slice data included in the criterion stream and the non-criterion stream in the time direction as a method corresponding to the process of dividing the image data of the plurality of image files obtained as the decoding result of the multi-stream in the time direction to form the image data of each image file. Thus, the multi-stream can be generated merely by rewriting the slice headers of the criterion stream and the non-criterion stream.

On the other hand, when a mobile terminal displays image data of a plurality of image files obtained as the decoding result of a multi-stream without performing any process on the image data, the mobile terminal displays images which are obtained by multiplexing images of a criterion stream and a non-criterion stream in the time direction. However, since this display is not generally used, the method of generating the multi-stream in the image processing device 101 is not suitable in this case.

Since the image processing device 101 multiplexes the slice data of the criterion stream and the non-criterion stream in the time direction, the restriction at the time of the encoding of the criterion stream and the non-criterion stream is less imposed. When the criterion stream and the non-criterion stream are encoded, it is not necessary to impose restriction of a prediction mode.

Since the image processing device 101 multiplexes the slice data of the criterion stream and the non-criterion stream in the time direction, it is not necessary to lower the resolution of the slice data, as in the case of the multiplexing inside a screen. As a result, a high-resolution image can be displayed, for example, when images of respective image files are displayed on one screen, as in a case in which the post-processing unit 121 is connected and supplies the image data of the respective image files to the display unit 33 using a transition process such as cross-fade.

Even in the second embodiment, the restriction that the SPSs and the PPSs of the criterion stream and the non-criterion stream be the same may not be imposed, as in the first embodiment.

### Third Embodiment

### <Example of Configuration of Image Processing System Including Third Embodiment of Image Processing Device>

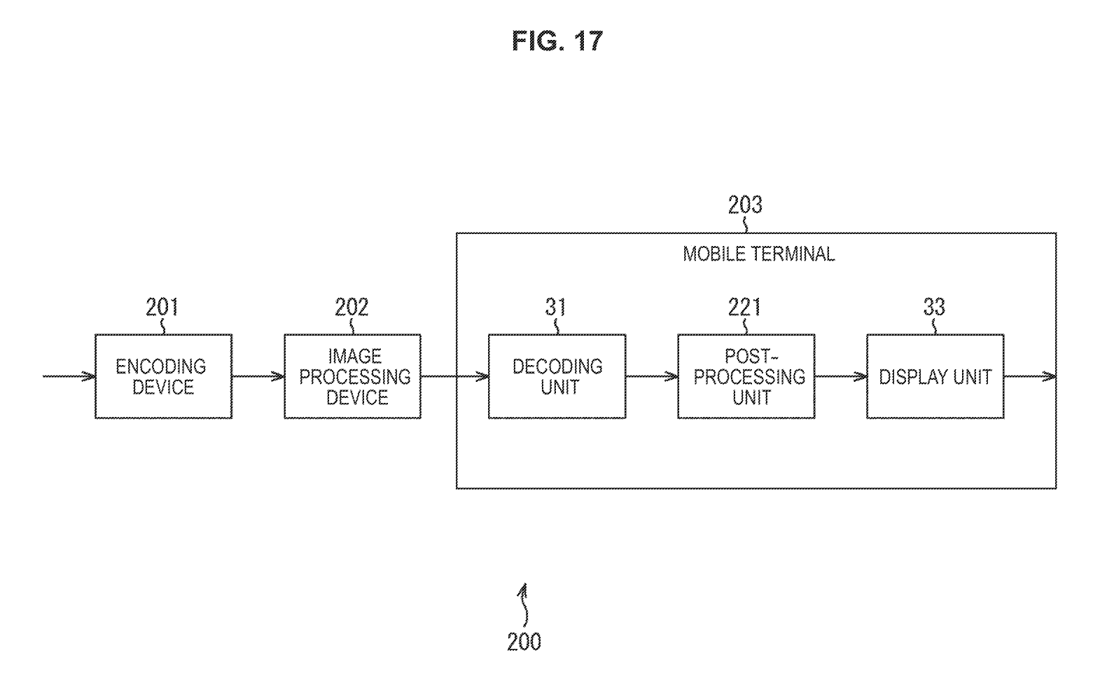

FIG. 17 is a block diagram illustrating an example of the configuration of an image processing system including a third embodiment of an image processing device to which the present technology is applied.

The same reference numerals are given to constituent elements having the same configuration as the configuration in FIG. 1 among constituent elements illustrated in FIG. 17.

An image processing system 200 in FIG. 17 includes an encoding device 201, an image processing device 202, and a mobile terminal 203. The image processing system 200 generates a multi-stream from encoded streams of a plurality of image files, performs a process of dividing a decoded result of the multi-stream in a horizontal direction and deleting dummy images, and then displays the processing result.

Specifically, the encoding device 201 of the image processing system 200 adds image data of dummy images to both ends in the horizontal direction of the image data in units of slices of each of a plurality of image files (two image files in the third embodiment) input from the outside. The encoding device 201 encodes the image data in the units of slices to which the image data of the dummy images is added for each image file in conformity with an AVC scheme or the like under a predetermined restriction.

For example, the predetermined restriction means that an SPS and a PPS of image data of each image file are the same, a bit length of syntax is set to a bit length in which an emulation prevention byte is not generated at the time of generation of a multi-stream, an entropy coding mode flag (entropy_coding_flag) included in the PPS is set to 0 indicating Context-Adaptive Variable Length Coding (CAVLC), or restriction on the image data of the dummy images.

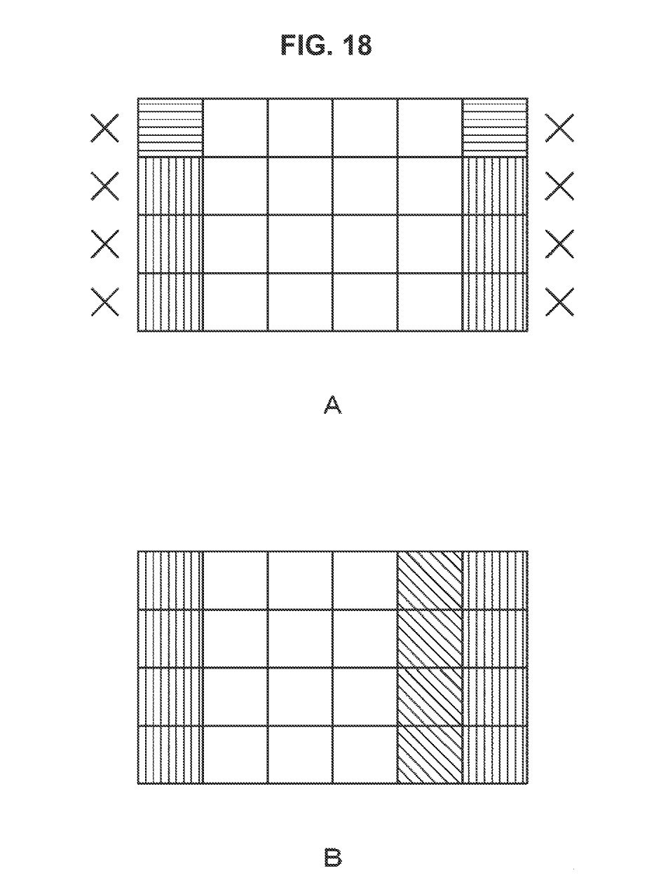

The entropy coding mode flag refers to information indicating a mode of entropy encoding performed at the time of encoding. The details of the restriction on the image data of the dummy images will be described below with reference to FIG. 18. The encoding device 201 supplies encoded streams of a plurality of image files obtained as an encoding result to the image processing device 202.

The image processing device 202 functions as a generation unit to generate a multi-stream from the encoded streams of the plurality of image files supplied from the encoding device 201. Specifically, the image processing device 202 multiplexes slice data included in each of the encoded streams of the plurality of image files in the horizontal direction to generate the multi-stream. The image processing device 202 supplies the multi-stream to the mobile terminal 203.

The configuration of the mobile terminal 203 is different from the configuration of the mobile terminal 13 in FIG. 1 in that a post-processing unit 221 is provided instead of the post-processing unit 32.

The post-processing unit 222 of the mobile terminal 203 divides the image data of the plurality of image files supplied from the decoding unit 31 in the horizontal direction, deletes the image data of the dummy images, and supplies the divided image data obtained as the deletion result as image data of each image file to the display unit 33.

### <Description of Restriction at Time of Encoding of Image Data of Dummy Images>

FIGS. 18A and 18B are diagrams illustrating the restriction at the time of the encoding of the image data of the dummy images.

In FIGS. 18A and 18B, squares indicate macro blocks and squares marked with vertical or horizontal lines indicate macro blocks of the dummy images. Further, unmarked squares and squares marked with diagonal lines indicate macro blocks in the units of slices of the encoded stream of each image file.

As illustrated in FIGS. 18A and 18B, the encoding device 201 adds the image data of the dummy image corresponding to one macro block to each of both ends in the horizontal direction of the image data in the units of slices and encodes the image data of the dummy images.

The first restriction at the time of the image data of the dummy images is that a coefficient (NonZeroCoef) of the dummy image be set to 0. A second restriction is that when a slice is Islice, a prediction mode of the macro blocks of two dummy images indicated by the squares marked with the horizontal lines in FIG. 18A be set to an intra-DC mode in which a prediction block has a size of 16×16 pixels and a prediction mode of the macro blocks of the dummy images indicated by the squares marked with the vertical lines in FIG. 18A be set to an intra-Vertical mode in which a prediction block has a size of 16×16 pixels.

That is, in the case of an intra-prediction mode in which a prediction block has a size other than 16×16 pixels, the prediction mode propagates to rear macro blocks. Specifically, when the prediction mode of a target macro block and macro blocks adjacent to the target macro block on the left and upper sides is the intra-prediction mode in which the prediction block has a size other than 16×16 pixels, the prediction of the target macro block is determined based on the prediction mode of the target macro block and macro blocks adjacent to the target macro block on the left and upper sides.

Accordingly, when the macro blocks of the encoded stream disposed on the right side of the macro block of the dummy image in the multi-stream are decoded, the prediction mode of the macro block of the dummy image is set to the intra-prediction mode in which the prediction block has a size other than 16×16 pixels so that the intra-prediction mode of the dummy image has no influence.

The prediction mode of the dummy image indicated by the square marked with the horizontal lines in FIG. 18A is set to the DC mode and the prediction mode of the dummy image indicated by the square marked with the vertical lines is set to the vertical mode so that an image other than the dummy image is not referred to at the time of the encoding of the dummy image.

A third restriction is that when a slice is Pslice, a prediction mode of the dummy image indicated by the square marked with the vertical lines in FIG. 9B be set to an inter-prediction mode in which a prediction block has a size of 16×16 pixels so as not to be referred to by other macro blocks.

That is, for the same reason as in the case of the intra-prediction mode, the size of the prediction is considered to be 16×16 pixels even at the time of the inter-prediction mode. Since the dummy image is deleted after the decoding, the dummy image is considered not to be referred to by the other macro blocks.

A fourth restriction is that when a slice is Islice or a Pslice, a difference value (mb_qp_delta) between quantization parameters QP be adjusted so that the values of the quantization parameters QP of the macro blocks of the dummy images indicated by the squares marked with the horizontal lines and the vertical lines in FIG. 18A and the macro blocks of the dummy images indicated by the squares marked with the vertical lines in FIG. 18B are constant values.

That is, the quantization parameters QP propagate in a raster scan order. Accordingly, the quantization parameters QP of the macro blocks of the dummy images are set to be the same so that the quantization parameter QP of a subsequent macro block of the dummy image in the raster scan order in the multi-stream is not changed from the quantization parameter QP in an encoded stream.

When a slice is Pslice, compression efficiency can be improved by setting an encoding mode of the macro block of the dummy image indicated by the square marked with the vertical lines in FIG. 18B to a skip mode. However, at this time, the restriction that the difference value (mb_qp_delta) be adjusted so that the quantization parameters QP of the macro blocks of the encoded stream indicated by the squares marked with the diagonal lines in FIG. 18B are constant values is imposed.

The encoding device 201 encodes the image data in the units of slices of each image file to which the image data of the dummy images is added to generate an encoded image under the above-described restrictions including the restriction on the above-described image data of the dummy images.

Thus, by multiplexing the slice data of the encoded stream in the horizontal direction without re-encoding the slice data, it is possible to generate the slice data of the multi-stream decodable in conformity with a standard. Since it is not necessary to divide the slice in units of rows, the macro blocks in the slice boundary in which the prediction mode is restricted can be reduced, and thus encoding efficiency can be improved.

In the second embodiment, there are Islice and Pslice as the kinds of slices. However, Bslice may be used as a kind of slice.

### <Example of Configuration of Image Processing Device>

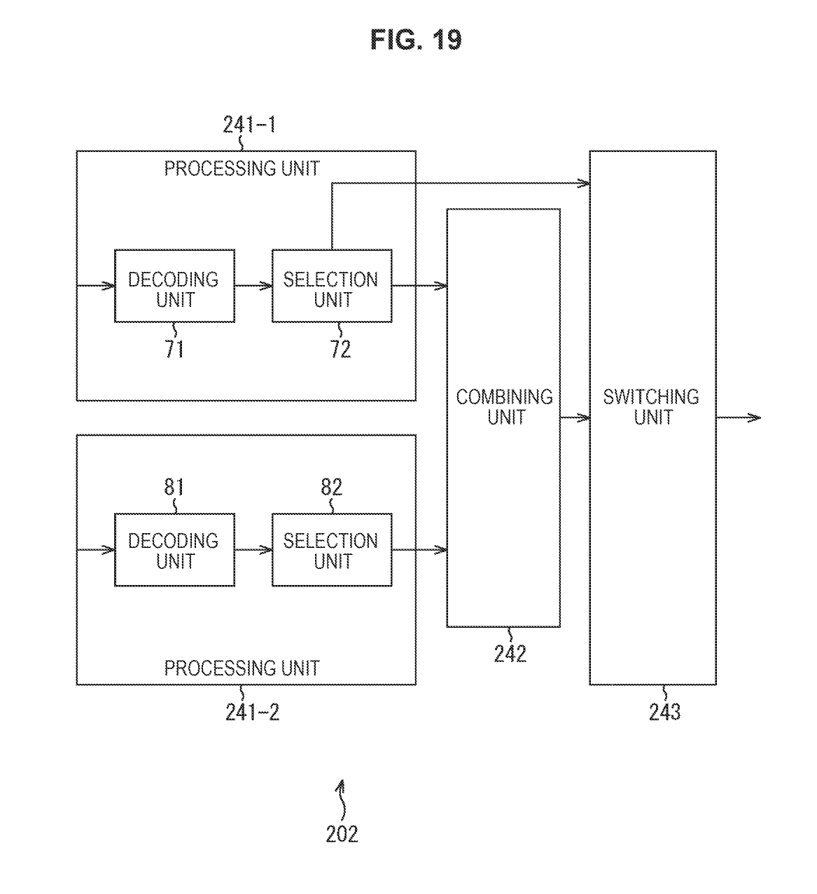

FIG. 19 is a block diagram illustrating an example of the configuration of the image processing device 202 in FIG. 17.

The same reference numerals are given to constituent elements having the same configuration as the configuration in FIG. 2 among constituent elements illustrated in FIG. 19.

The image processing device 202 in FIG. 19 includes a processing unit 241-1, a processing unit 241-2, a combining unit 242, and a switching unit 243.

The configuration of the processing unit 241-1 of the image processing device 202 is different from the configuration of the processing unit 51-1 in FIG. 2 in that the analysis unit 73 and the rewriting unit 74 are not provided. The SPS, the PPS, and the delimiter selected as valid data by the selection unit 72 are supplied to the switching unit 243 and the slice data is supplied to the combining unit 242.

The configuration of the processing unit 241-2 of the image processing device 202 is different from the configuration of the processing unit 51-2 in FIG. 2 in that the analysis unit 83 and the rewriting unit 84 are not provided. The slice data selected as valid data by the selection unit 82 is supplied to the combining unit 242.

The combining unit 242 multiplexes a data portion of the slice data supplied from the selection unit 72 and a data portion of the slice data supplied from the selection unit 82 in the horizontal direction and adds a slice header to generate slice data. The slice header is generated based on the slice headers of the criterion stream and the non-criterion stream. The combining unit 242 supplies the generated slice data to the switching unit 243.

The switching unit 243 outputs the SPS and the PPS supplied from the selection unit 72 as the multi-stream and outputs the slice data supplied from the combining unit 242 as the multi-stream. Thereafter, the switching unit 243 outputs the delimiter supplied from the selection unit 72 as the multi-stream.

### <Example of Configuration of Multi-Stream>

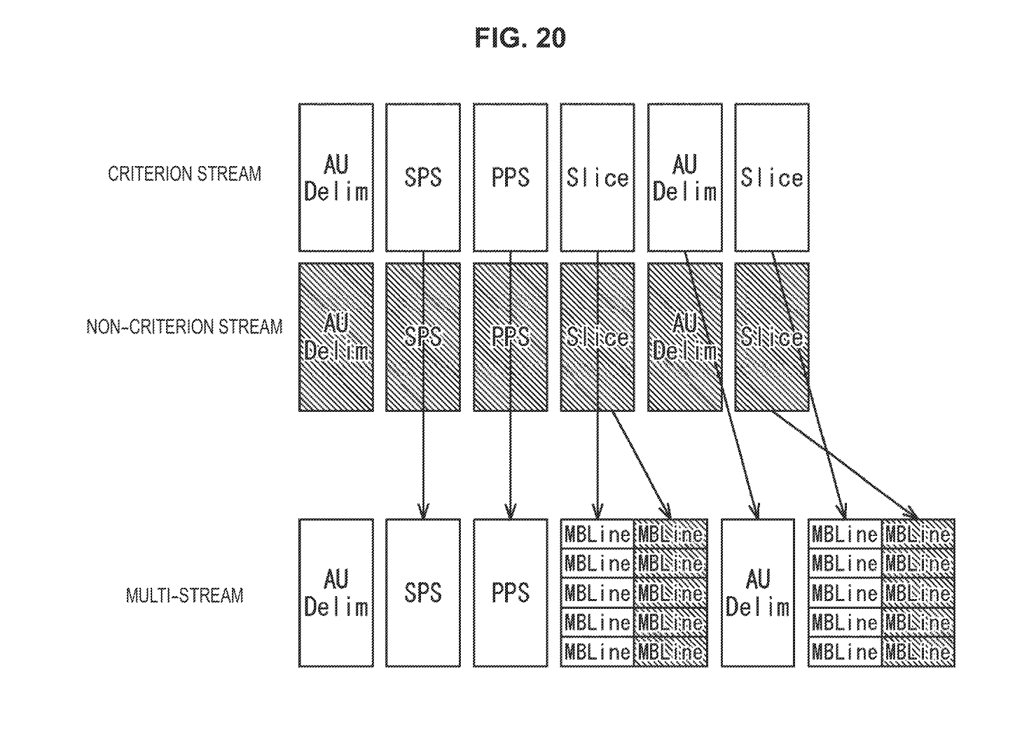

FIG. 20 is a diagram illustrating an example of the configuration of the multi-stream.

As illustrated in FIG. 20, the multi-stream includes the SPS, the PPS, and the delimiter included in the criterion stream and includes the slice data in which the data portions of the slice data of the criterion stream and the non-criterion stream are multiplexed in the horizontal direction. Thus, the multi-stream becomes an encoded stream in which the slice of the criterion stream and the slice of the non-criterion stream are multiplexed in the horizontal direction and one slice is thus formed.

In the third embodiment, the SPS and the PPS of the criterion stream are used without change as the SPS and the PPS of the multi-stream, but may be updated and used, as necessary.

### <Example of Decoded Result of Multi-Stream>

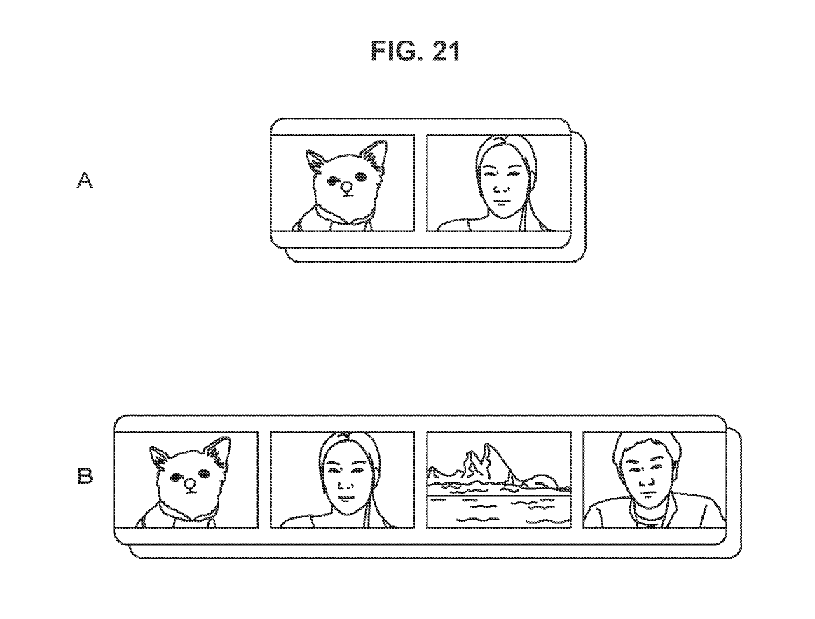

FIGS. 21A and 21B are diagrams illustrating examples of decoded results of the multi-stream.

As described above, the multi-stream is the encoded stream in which the slice of the criterion stream and the slice of the non-criterion stream are multiplexed in the horizontal direction and one slice is thus formed. Accordingly, when the multi-stream is decoded, as illustrated in FIG. 21A, images in which an image corresponding to the criterion stream and an image corresponding to the non-criterion stream are multiplexed in the horizontal direction are generated.

Likewise, for example, when a multi-stream is generated from encoded streams of four image files, as illustrated in FIG. 21B, images for which an image corresponding to the criterion stream and images corresponding to three non-criterion streams are multiplexed in the horizontal direction are generated.

### <Description of Process of Image Processing Device>

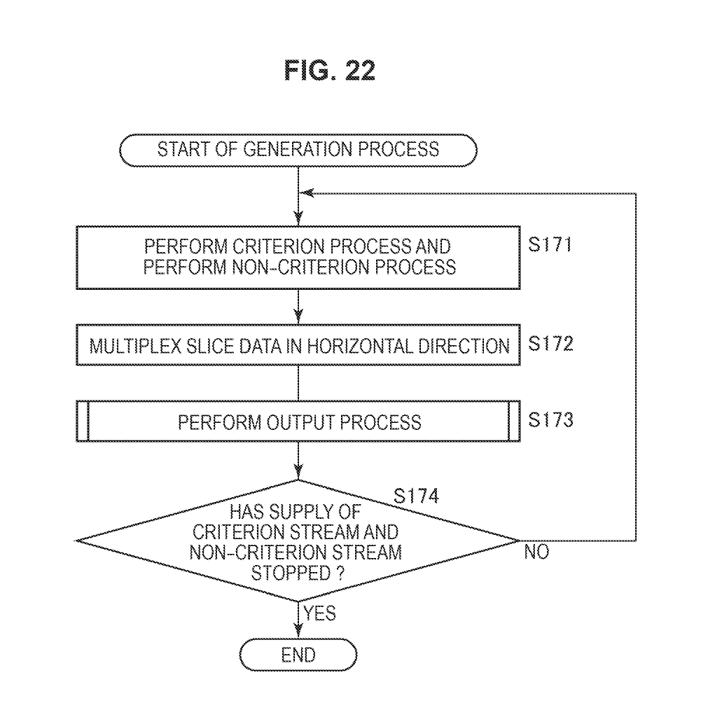

FIG. 22 is a flowchart for describing a generation process of the image processing device 202 in FIG. 19. The generation process starts when supply of the criterion stream and the non-criterion stream from the encoding device 201 starts.

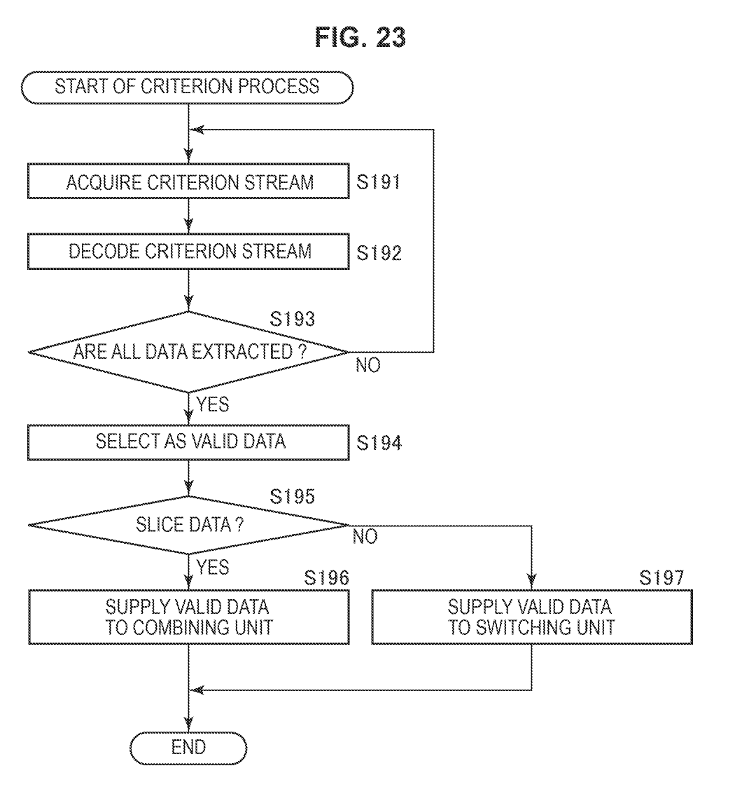

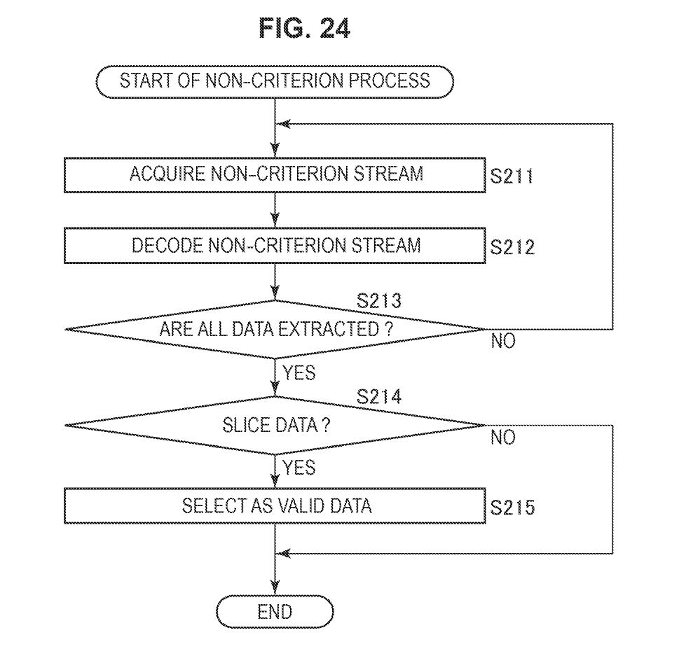

In step S171 of FIG. 22, the processing unit 241-1 performs a criterion process and the processing unit 241-2 performs a non-criterion process. The details of the criterion process will be described below with reference to FIG. 23. The details of the non-criterion process will be described below with reference to FIG. 24.

In step S172, the combining unit 242 multiplexes the data portion of the slice data supplied from the selection unit 72 and the data portion of the slice data supplied from the selection unit 82 in the horizontal direction and adds the slice header to generate the slice data. The combining unit 242 supplies the generated slice data to the switching unit 243.

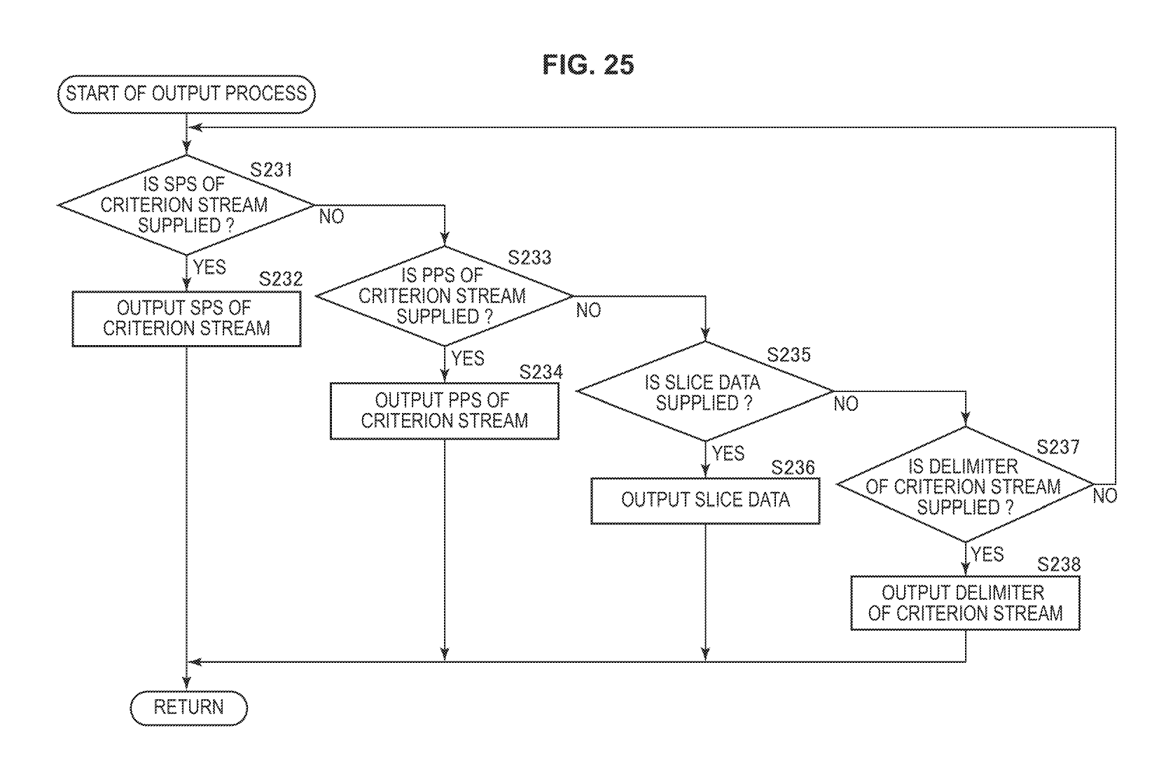

In step S173, the switching unit 243 performs an output process of outputting the SPS, the PPS, and the delimiter supplied from the processing unit 241-1 and the slice data supplied from the combining unit 242 in order. The details of the output process will be described below with reference to FIG. 25.

In step S714, the switching unit 243 determines whether the criterion stream and the non-criterion stream are not supplied. When the criterion stream and the non-criterion stream are supplied in step S174, the process returns to step S171 and the processes of step S171 to step S174 are repeated.

Conversely, when it is determined in step S174 that the criterion stream and the non-criterion stream are not supplied, the process ends.

FIG. 23 is a flowchart for describing the details of the criterion process in step S171 of FIG. 22.

Since the processes of step S191 to step S193 of FIG. 23 are the same as the processes of step S31 to step S33 of FIG. 6, the description will be omitted.

In step S194, the selection unit 72 selects the SPS, the PPS, the encoded data, and the delimiter supplied from the decoding unit 71 as the valid data.

In step 195, the selection unit 72 determines whether the valid data is the slice data. When the selection unit 72 determines in step S195 that the valid data is the slice data, the selection unit 72 supplies the slice data as the valid data to the combining unit 242 in step S196, and then the process ends.

Conversely, when the selection unit 72 determines in step S195 that the valid data is not the slice data, the selection unit 72 supplies the SPS, the PPS, the delimiter and the valid data to the switching unit 243 in step S197, and then the process ends.

FIG. 24 is a flowchart for describing the details of the non-criterion process in step S171 of FIG. 22.

Since the processes of step S211 to step S214 of FIG. 24 are the same as the processes of step S51 to step S54 of FIG. 7, the description will be omitted.

In step S215, the selection unit 82 selects the slice data as the valid data and supplies the slice data to the combining unit 242, and then the process ends.

FIG. 25 is a flowchart for describing the details of the output process in step S173 of FIG. 22.

Since the processes of step S231 to step S234 of FIG. 25 are the same as the processes of step S71 to step S74 of FIG. 8, the description will be omitted.

When the switching unit 243 determines in step S233 that the PPS of the criterion stream is not supplied, the switching unit 243 determines in step S235 whether the slice data is supplied from the combining unit 242.

When the switching unit 243 determines in step S235 that the slice data is supplied, the switching unit 243 outputs the slice data as the multi-stream in step S236. Then, the process returns to the process of step S173 of FIG. 22 and proceeds to step S174.

Conversely, when it is determined in step S235 that the slice data is not supplied, the process proceeds to step S237 to perform the same process as the process of step S79 of FIG. 8. In step S238, the same process as the process of step S80 of FIG. 8 is performed and the process returns to step S173 and proceeds to step S174.

As described above, the image processing device 202 generates the multi-stream according to the method of multiplexing the slice data included in the criterion stream and the non-criterion stream in the horizontal direction as a method corresponding to the process of dividing the image data of the plurality of image files obtained as the decoding result of the multi-stream in the horizontal direction and deleting the image data of the dummy images to form the image data of each image file. Thus, the multi-stream can be generated merely by combining the data portions of the slice data of the criterion stream and the non-criterion stream and adding the slice header.

On the other hand, when the mobile terminal displays image data of a plurality of image files obtained as the decoding result of a multi-stream without performing any process on the image data, the mobile terminal displays images which are obtained by multiplexing images of a criterion stream and a non-criterion stream, to which the image data of the dummy images is added, in the horizontal direction. However, since this display is not generally used, the method of generating the multi-stream in the image processing device 2022 is not suitable in this case.

Since the mobile terminal 203 deletes the image data of the dummy image, the encoding device 201 can add the image data of the dummy images to the image data of the criterion stream and the non-criterion stream and encode the image data. Accordingly, it is not necessary to impose the restrictions described with reference to FIGS. 18A and 18B on the actual image data and it is possible to prevent deterioration in quality and degradation of the encoding efficiency.

Since the image processing device 202 generates the multi-stream by multiplexing the slice data of the criterion stream and the non-criterion stream in the horizontal direction, the shape of the image of the multi-stream becomes a horizontally long shape with high affinity to a general decoder. As a result, decoders capable of processing the multi-stream can be increased.

Even in the third embodiment, the restriction that the SPSs and the PPSs of the criterion stream and the non-criterion stream be the same may not be imposed, as in the first embodiment.

### Fourth Embodiment

### <Example of Configuration of Image Processing System Including Fourth Embodiment of Image Processing Device>

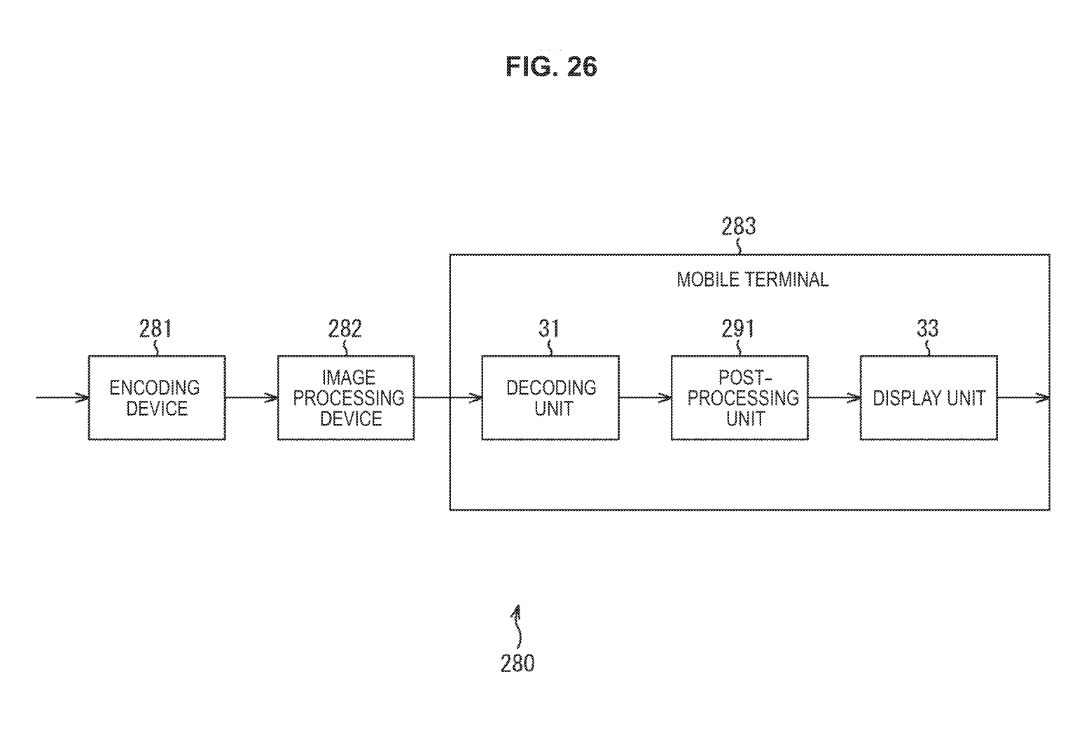

FIG. 26 is a block diagram illustrating an example of the configuration of an image processing system including a fourth embodiment of an image processing device to which the present technology is applied.

The same reference numerals are given to constituent elements having the same configuration as the configuration in FIG. 1 among constituent elements illustrated in FIG. 26. The repeated description will be appropriately omitted.

An image processing system 280 in FIG. 26 includes an encoding device 281, an image processing device 282, and a mobile terminal 283. The image processing system 280 is a system realized by combination of the systems of the first to third embodiments.

Specifically, the encoding device 281 adds image data of dummy images to both ends in the horizontal direction of the image data in units of slices of each of a plurality of image files (eight image files in the fourth embodiment) input from the outside. The encoding device 281 encodes the image data in the units of slices to which the image data of the dummy images is added for each image file in conformity with an AVC scheme or the like under the same restriction as the restriction on the encoding device 201 in FIG. 17.

The image processing device 282 functions as a generation unit to generate a multi-stream from the encoded streams of the plurality of image files supplied from the encoding device 281. Specifically, the image processing device 282 multiplexes slice data included in the encoded streams in the horizontal direction for every two image files among the plurality of image files. The image processing device 282 multiplexes the slice data multiplexed in the horizontal direction in the vertical direction and multiplexes the slice data in the time direction to form the multi-stream. The image processing device 282 supplies the multi-stream to the mobile terminal 283.

The configuration of the mobile terminal 283 is different from the configuration of the mobile terminal 13 in FIG. 1 in that a post-processing unit 291 is provided instead of the post-processing unit 32.

The post-processing unit 291 of the mobile terminal 283 divides the image data of the plurality of image files supplied from the decoding unit 31 in the time direction, the vertical direction, and the horizontal direction, and deletes the image data of the dummy images. The post-processing unit 291 supplies the divided image data obtained as the deletion result as image data of each image file to the display unit 33.

### <Example of Configuration of Image Processing Device>

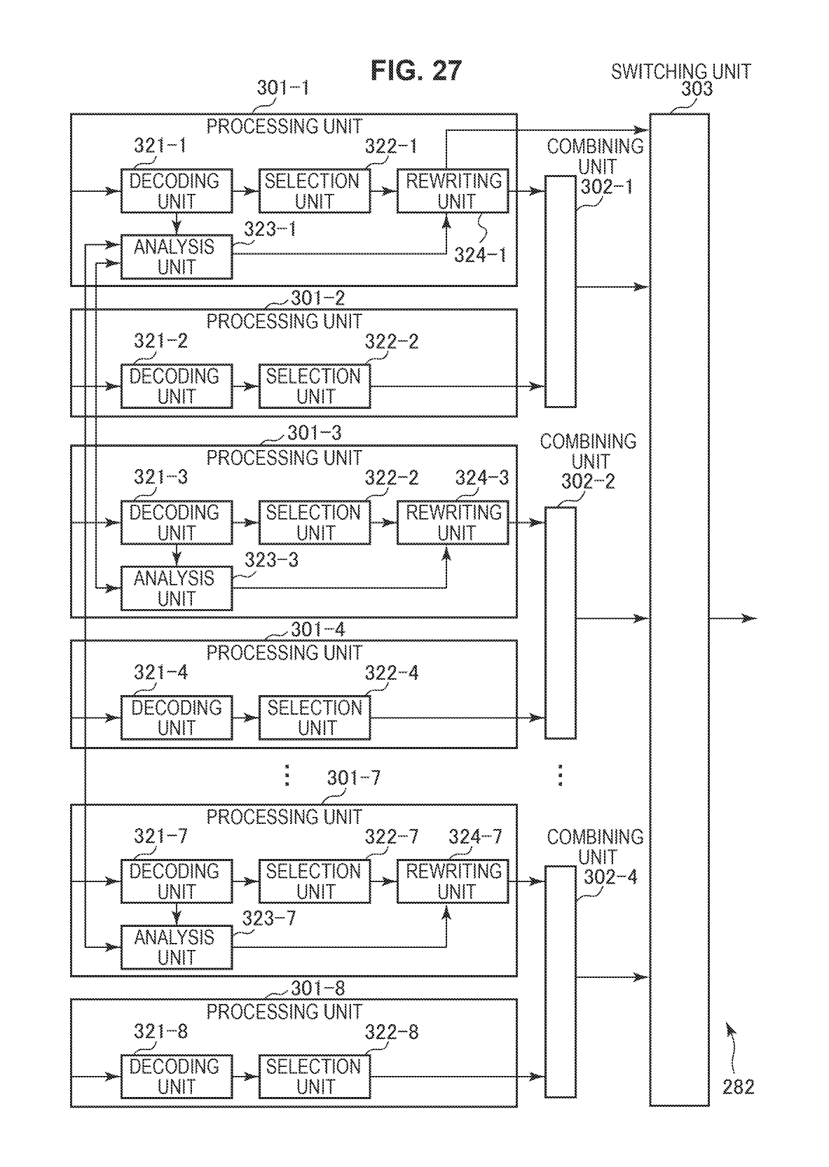

FIG. 27 is a block diagram illustrating an example of the configuration of the image processing device 282 in FIG. 26.

The image processing device 282 in FIG. 27 includes processing units 301-1 to 301-8, combining units 302-1 to 302-4, and a switching unit 303.

The processing unit 301-1 of the image processing device 282 includes a decoding unit 321-1, a selection unit 322-1, an analysis unit 323-1, and a rewriting unit 324-1.

The decoding unit 321-1 of the processing unit 301-1 has the same configuration as the decoding unit 71 in FIG. 2. That is, the decoding unit 321-1 acquires one encoded stream supplied from the encoding device 281 in FIG. 26 as a criterion stream. The decoding unit 321-1 decodes the criterion stream to extract an SPS, a PPS, slice data, and a delimiter included in the criterion stream. The decoding unit 321-1 supplies the extracted SPS, PPS, slice data, and delimiter to the selection unit 322-1 and supplies the slice data to the analysis unit 323-1.

The selection unit 322-1 has the same configuration as the selection unit 72. That is, the selection unit 322-1 selects the SPS, the PPS, the slice data, and the delimiter supplied from the decoding unit 321-1 as valid data and supplies the SPS, the PPS, the slice data, and the delimiter to the rewriting unit 324-1.

The analysis unit 323-1 extracts the slice header from the slice data supplied from the decoding unit 321-1. The analysis unit 323-1 analyzes the slice header to acquire a frame number, POC information, and reference picture change information included in the slice header.

The analysis unit 323-1 acquires the frame number and the POC information of a non-criterion stream from the processing unit 301-3. The analysis unit 323-1 determines a common frame number common to the criterion stream and the non-criterion stream based on the frame numbers of the criterion stream and the non-criterion stream. Likewise, the analysis unit 323-1 determines common POC information. The analysis unit 323-1 supplies the common frame number and the common POC information to an analysis unit 323-3.

The analysis unit 323-1 determines the frame number, the POC information, and the reference picture change information in the multi-stream based on the common frame number, the common POC information, the reference picture change information, the number of encoded streams used in the multi-stream, a reference picture specified by the PPS, and the like. The analysis unit 161 supplies the determined frame number, POC information, and reference picture change information in the multi-stream to the rewriting unit 324-1.

The rewriting unit 324-1 supplies the SPS, the PPS, and the delimiter supplied from the selection unit 322-1 to the switching unit 52 without change. The rewriting unit 324-1 rewrites the frame number, the POC information, and the reference picture change information included in the slice header of the slice data supplied from the selection unit 322-1 with the frame number, the POC information, and the reference picture change information supplied from the analysis unit 323-1. The rewriting unit 324-1 supplies the rewritten slice data to the combining unit 302-1.

The processing unit 301-2 includes a decoding unit 321-2 and a selection unit 322-2.

The decoding unit 321-2 has the same configuration as the decoding unit 81. That is, the decoding unit 321-2 decodes one encoded stream supplied from the encoding device 281 as a non-criterion stream to extract an SPS, a PPS, slice data, and a delimiter included in the criterion stream. The decoding unit 321-2 supplies the extracted SPS, PPS, slice data, and the delimiter to the selection unit 322-2.

The selection unit 322-2 selects the slice data as valid data among the SPS, the PPS, the slice data, and the delimiter supplied from the decoding unit 321-2 and supplies the SPS, the PPS, the slice data, and the delimiter to the combining unit 302-1.

The combining unit 302-1 has the same configuration as the combining unit 242 in FIG. 19. That is, the combining unit 302-1 multiplexes a data portion of the slice data supplied from the rewriting unit 324-1 and a data portion of the slice data supplied from the selection unit 322-2 in the horizontal direction and adds a slice header to generate slice data. The combining unit 302-1 supplies the generated slice data to the switching unit 303.

The processing unit 301-3 includes a decoding unit 321-3, a selection unit 322-3, an analysis unit 323-3, and a rewriting unit 324-3.

The decoding unit 321-3 of the processing unit 301-3 has the same configuration as the decoding unit 321-1, supplies the SPS, the PPS, the slice data, and the delimiter to the selection unit 322-3, and supplies the slice data to the analysis unit 323-3.

The selection unit 322-3 has the same configuration as the selection unit 322-2 and supplies the slice data as valid data to the rewriting unit 324-3.

The analysis unit 323-3 extracts the slice header from the slice data supplied from the decoding unit 321-3. The analysis unit 323-3 analyzes the slice header to acquire a frame number, POC information, reference picture change information, and head macro information included in the slice header. The analysis unit 323-3 supplies the frame number and the POC information to the analysis unit 323-1 of the processing unit 301-1 and accordingly acquires the common frame number and the common POC information from the analysis unit 323-1.

The analysis unit 323-3 determines the head macro information in the multi-stream based on the head macro information of the non-criterion stream. The analysis unit 323-3 determines the reference picture change information in the multi-stream based on the reference picture change information, the number of encoded streams used in the multi-stream, the reference picture specified by the PPS, and the like. The analysis unit 323-3 supplies the common frame number, the common POC information, the head macro information, and the reference picture change information to the rewriting unit 324-3.

The rewriting unit 324-3 rewrites the frame number, the POC information, the head macro information, and the reference picture change information supplied from the selection unit 322-3 with the common frame number, the common POC information, the head macro information, and the reference picture change information supplied from the analysis unit 323-3. The rewriting unit 324-3 supplies the rewritten slice data to the combining unit 302-2.

The processing unit 301-4 includes a decoding unit 321-4 and a selection unit 322-4.

The decoding unit 321-4 has the same configuration as the decoding unit 321-2 and the selection unit 322-4 has the same configuration as the selection unit 322-2. Thus, the slice data is selected as valid data and is supplied to the combining unit 302-2.

The combining unit 302-2 has the same configuration as the combining unit 302-1. Thus, a data portion of the slice data supplied from the rewriting unit 324-3 and a data portion of the slice data supplied from the selection unit 322-4 are multiplexed in the horizontal direction to generate the slice data, and the generated slice data is supplied to the switching unit 303.

The processing units 301-5 to 301-8 have the same configuration as the processing units 301-1 to 301-4 except that a selection unit 322-1 of the processing unit 301-5 selects only slice data and a delimiter as valid data and a rewriting unit 324-7 supplies the delimiter to the switching unit 303.

Thus, the slice data of two non-criterion streams is supplied to each of the combining units 302-3 and 302-4, one piece of slice data is generated, and the generated slice data is supplied to the switching unit 303. The delimiter is supplied from the rewriting unit 324-7 to the switching unit 303.

The switching unit 303 outputs the SPS and the PPS supplied from the rewriting unit 324-1 of the processing unit 301-1 as the multi-stream in order. The switching unit 303 outputs the slice data supplied from the combining unit 302-1 and the slice data supplied from the combining unit 302-2 as the multi-stream in order. Thereafter, the switching unit 303 outputs the delimiter supplied from the rewriting unit 324-1 as the multi-stream.

Then, the switching unit 303 outputs the slice data supplied from the combining unit 302-3 and the slice data supplied from the combining unit 302-4 as the multi-stream in order. Thereafter, the switching unit 303 outputs the delimiter supplied from the rewriting unit 324-5 of the processing unit 301-5 as the multi-stream.

Through the rewriting of the rewriting unit 324-1 (324-3, 324-5, and 324-7), the bit length of the syntax is changed. However, the restriction that when the criterion stream is generated, the bit length of the syntax be set to a bit length in which an emulation prevention byte is not generated at the time of generation of a multi-stream is imposed. Therefore, the emulation prevention byte is not generated.

### <Example of Configuration of Multi-Stream>

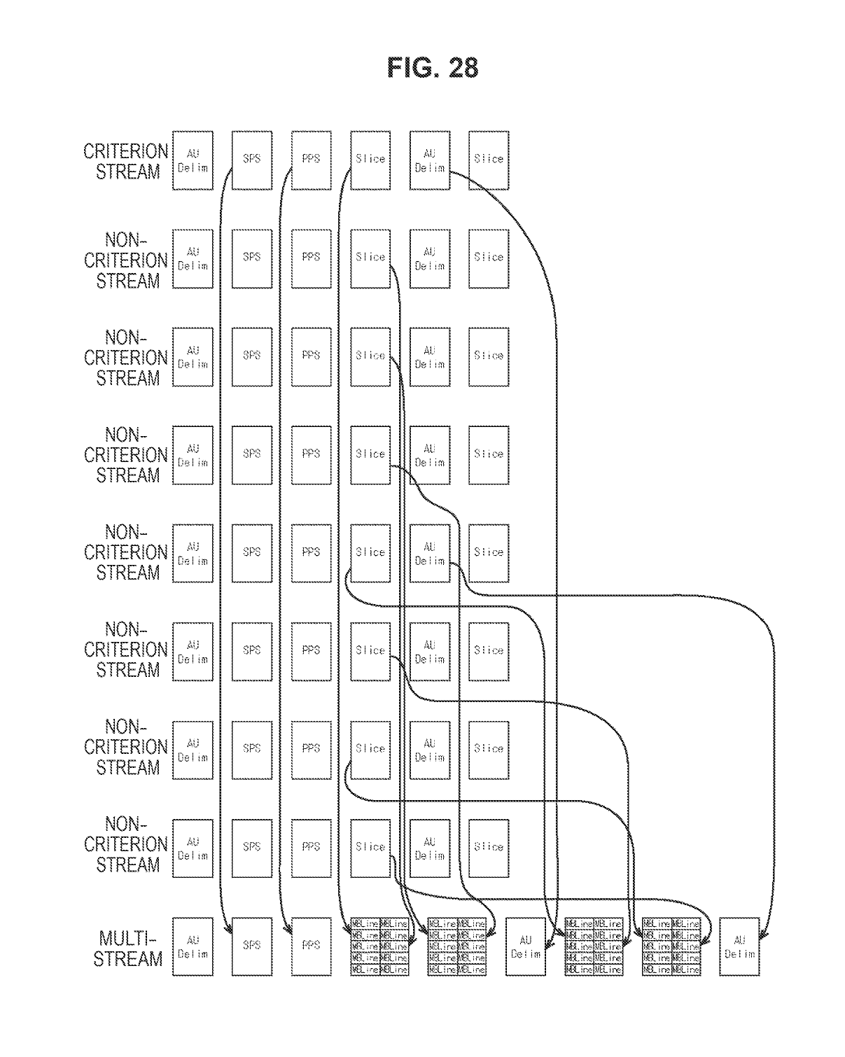

FIG. 28 is a diagram illustrating an example of the configuration of the multi-stream.

As illustrated in FIG. 28, the multi-stream includes the SPS, the PPS, and the delimiter included in the criterion stream, four pieces of slice data in which the data portions of the slice data of the criterion stream and the non-criterion streams are multiplexed in the horizontal direction, and the delimiter of the non-criterion stream.

Thus, the multi-stream is an encoded stream in which pictures formed from a slice in which the slice of the criterion stream and the slice of the non-criterion stream are multiplexed in the horizontal direction and a slice in which the slices of two non-criterion streams are multiplexed in the horizontal direction, and pictures formed from two slices in which the slices of two non-criterion streams are multiplexed in the horizontal direction are alternately disposed.

In the fourth embodiment, the SPS and the PPS of the criterion stream are used without change as the SPS and the PPS of the multi-stream, but may be updated and used, as necessary.

### <Example of Decoded Result of Multi-Stream>

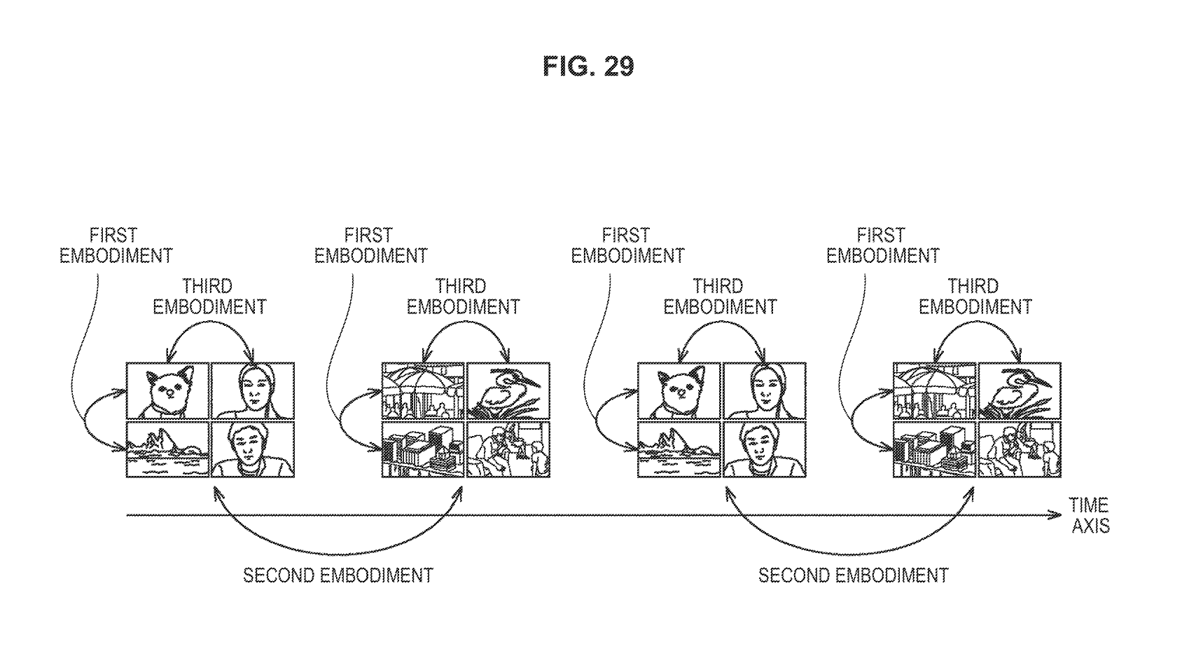

FIG. 29 is a diagram illustrating an example of a decoding result of the multi-stream.

As described above, the multi-stream is an encoded stream in which the pictures formed from the slice in which the slice of the criterion stream and the slice of the non-criterion stream are multiplexed in the horizontal direction and the slice in which the slices of two non-criterion streams are multiplexed in the horizontal direction, and the pictures formed from two slices in which the slices of two non-criterion streams are multiplexed in the horizontal direction are alternately disposed.

Accordingly, when the multi-stream is decoded, as illustrated in FIG. 29, images are generated in such a manner that images in which horizontally long images obtained by multiplexing an image corresponding to the criterion stream and an image corresponding to the non-criterion stream in the horizontal direction, and horizontally long images obtained by multiplexing images corresponding to two non-criterion streams in the horizontal direction are multiplexed in the vertical direction: and images in which two horizontal long images obtained by multiplexing images corresponding to two non-criterion streams in the horizontal direction are multiplexed in the vertical direction are multiplexed in the time direction.

### <Description of Process of Image Processing Device>

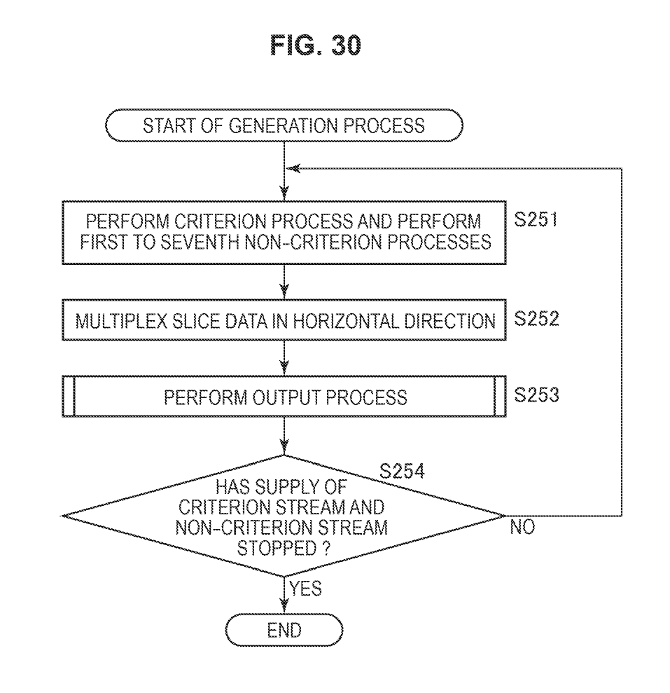

FIG. 30 is a flowchart for describing a generation process of the image processing device 282 in FIG. 26. The generation process starts when supply of the criterion stream and the seven non-criterion streams from the encoding device 281 starts.

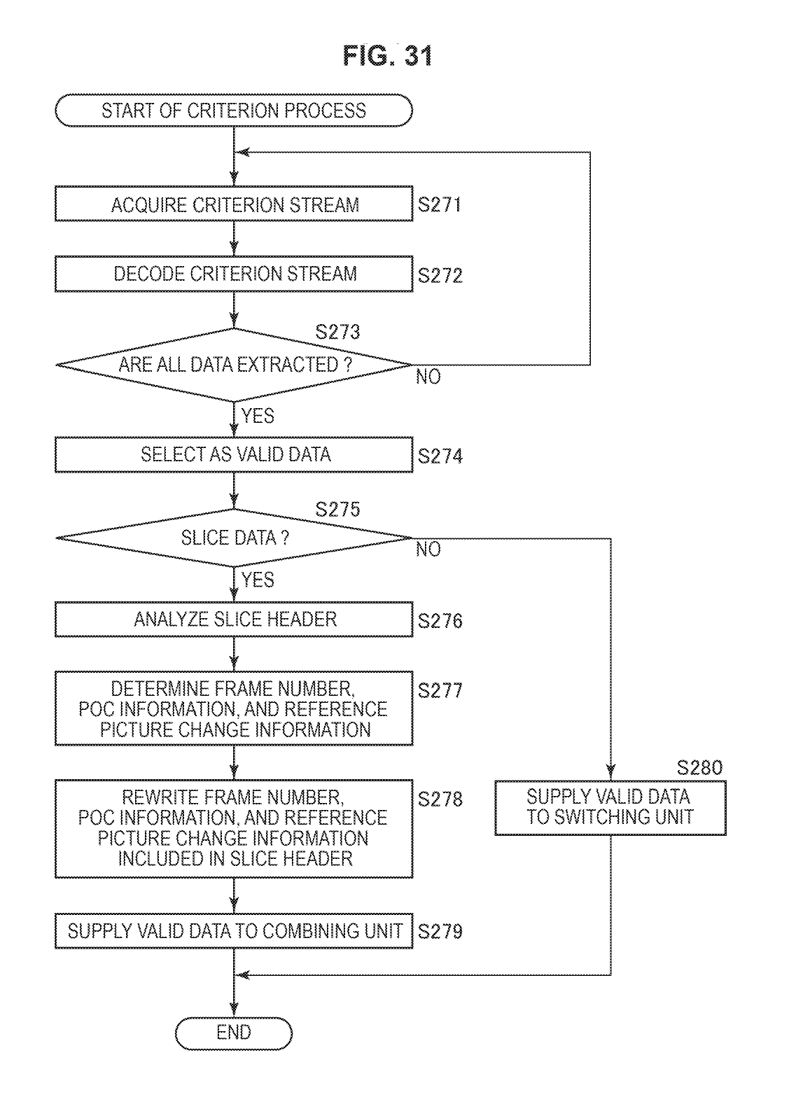

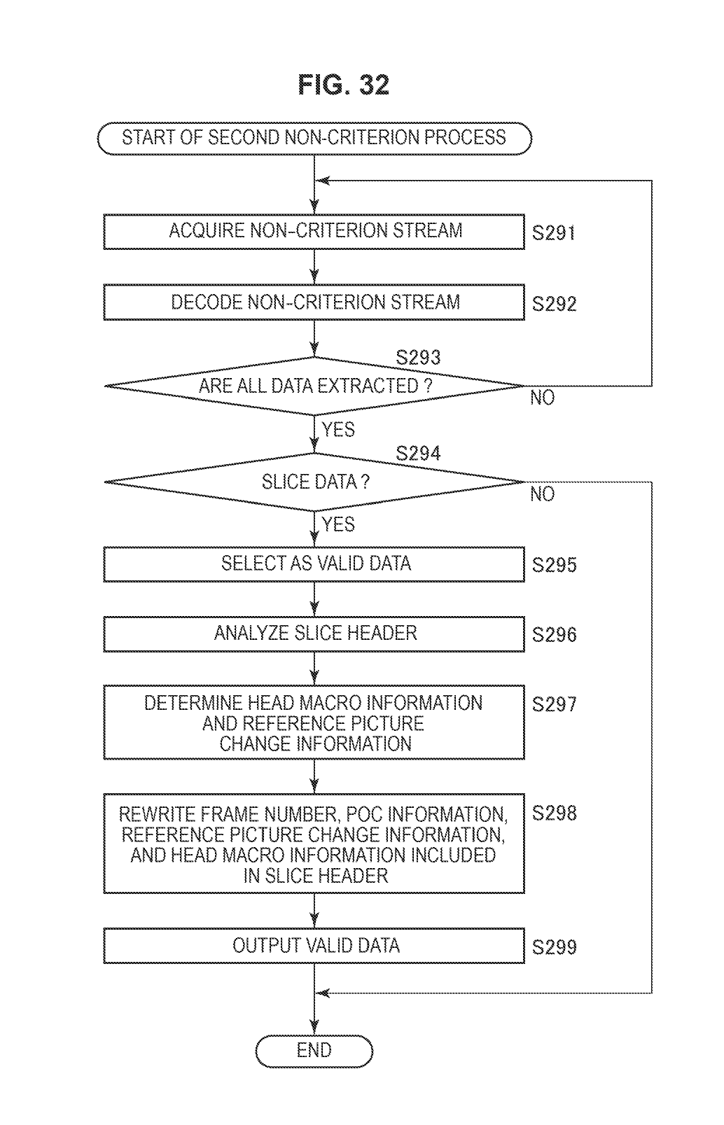

In step S251 of FIG. 30, the processing unit 301-1 performs a criterion process and the processing units 301-2 to 301-8 perform first to seventh non-criterion processes, respectively. The details of the criterion process will be described below with reference to FIG. 31. The details of the first to seventh non-criterion processes will be described below with reference to FIG. 32.

In step S252, the combining unit 302-1 multiplexes the data portion of the slice data supplied from the rewriting unit 324-1 and the data portion of the slice data supplied from the selection unit 322-2 in the horizontal direction and adds the slice header to generate the slice data. The combining unit 302-1 supplies the generated slice data to the switching unit 303.

Likewise, the combining unit 302-2 generates the slice data from the slice data supplied from the rewriting unit 324-3 and the slice data supplied from the selection unit 322-4 and supplies the generated slice data to the switching unit 303. The combining unit 302-3 generates the slice data from the slice data supplied from the rewriting unit 324-5 and the slice data supplied from the selection unit 322-6 and supplies the generated slice data to the switching unit 303. The combining unit 302-4 generates the slice data from the slice data supplied from the rewriting unit 324-7 and the slice data supplied from the selection unit 322-8 and supplies the generated slice data to the switching unit 303.

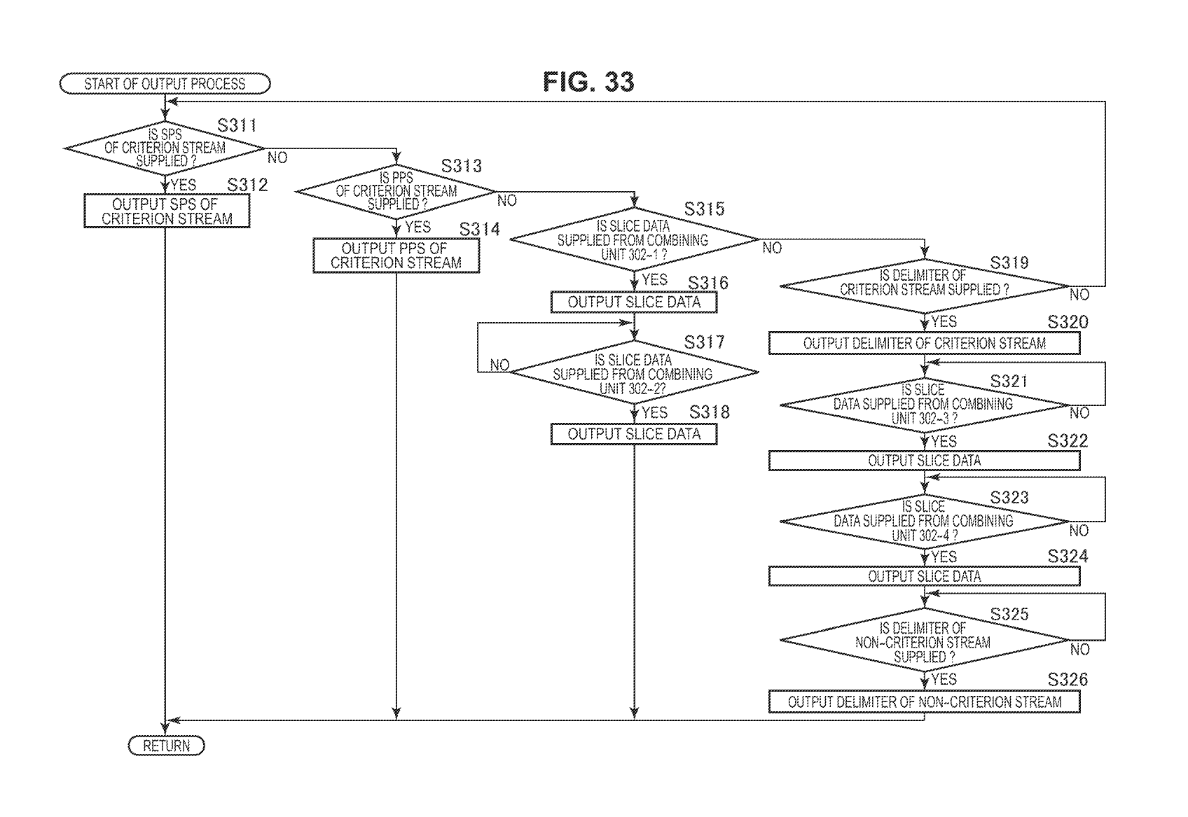

In step S253, the switching unit 303 performs an output process of outputting the SPS, the PPS, and the delimiter supplied from the rewriting unit 324-1, the delimiter supplied from the rewriting unit 324-5, and the slice data supplied from the combining units 302-1 to 302-4 in order. The details of the output process will be described below with reference to FIG. 33.

In step S254, the switching unit 303 determines whether supply of the criterion stream and the seven non-criterion streams has stopped. When supply of the criterion stream and the seven non-criterion streams has not stopped in step S254, the process returns to step S251 and the processes of step S251 to step S254 are repeated.

Conversely, when it is determined in step S254 that supply of the criterion stream and the seven non-criterion streams has stopped, the process ends.

FIG. 31 is a flowchart for describing the details of the criterion process in step S251 of FIG. 30.

Since the processes of step S271 to S275 of FIG. 31 are the same as the processes of step S31 to step S35 of FIG. 6, the description will be omitted.

In step S276, the analysis unit 323-1 analyzes the slice header included in the slice data supplied from the decoding unit 321-1 to acquire the frame number, the POC information, and the reference picture change information included in the slice header. Further, the analysis unit 323-1 acquires the frame number and the POC information of the non-criterion stream from the analysis unit 323-3 of the processing unit 301-3.

In step S277, the analysis unit 323-1 determines the common frame number common to the criterion stream and the non-criterion stream based on the frame numbers of the criterion stream and the non-criterion stream and determines the common POC information based on the POC information of the criterion stream and the non-criterion stream.

The analysis unit 323-1 determines the frame number, the POC information, and the reference picture change information in the multi-stream based on the common frame number, the common POC information, the reference picture change information, the number of encoded streams used in the multi-stream, the reference picture specified by the PPS, and the like. The analysis unit 83 supplies the common frame number and the common POC information to the analysis unit 323-3 and supplies the frame number, the POC information, and the reference picture change information in the multi-stream to the rewriting unit 324-1.

In step S278, the rewriting unit 324-1 rewrites the frame number, the POC information, and the reference picture change information included in the slice header of the slice data supplied from the selection unit 322-1 with the frame number, the POC information, and the reference picture change information supplied from the analysis unit 323-1. The rewriting unit 324-1 supplies the rewritten slice data to the combining unit 302-1.

In step S279, the rewriting unit 324-1 supplies the slice data rewritten as the valid data in step S278 to the combining unit 302-1, and then the process ends.

Conversely, when it is determined in step S275 that the data extracted in step S272 is not the slice data, the process proceeds to step S280. In step S280, the rewriting unit 324-1 supplies the SPS, the PPS, or the delimiter supplied as the valid data from the selection unit 322-1 to the switching unit 303, and then the process ends.

Since the first non-criterion process, the third non-criterion process, the fifth non-criterion process, and the seventh non-criterion process in step S251 of FIG. 30 are the same as the non-criterion process of FIG. 24, the description will be omitted.

FIG. 32 is a flowchart for describing the details of the second non-criterion process in step S251 of FIG. 30.

Since the processes of step S291 to step S295 of FIG. 32 are the same as the processes of step S51 to step S55 of FIG. 7, the description will be omitted.

In step S296, the analysis unit 323-3 analyzes the slice header included in the slice data supplied from the decoding unit 321-3 to acquire the frame number, the POC information, the reference picture change information, and the head macro information included in the slice header. The analysis unit 323-3 supplies the frame number and the POC information to the analysis unit 323-1 of the processing unit 301-1 and accordingly acquires the common frame number and the common POC information from the analysis unit 323-1.

In step S297, the analysis unit 323-3 determines the head macro information in the multi-stream based on the head macro information of the non-criterion stream. Further, the analysis unit 323-3 determines the reference picture change information in the multi-stream based on the reference picture change information, the number of encoded streams used in the multi-stream, the reference picture specified by the PPS, and the like. The analysis unit 323-3 supplies the common frame number, the common POC information, the head macro information, and the reference picture change information to the rewriting unit 324-3.

In step S298, the rewriting unit 324-3 rewrites the frame number, the POC information, the reference picture change information, and the head macro information included in the slice header of the slice data supplied from the selection unit 322-3 with the common frame number, the common POC information, the reference picture change information, and the head macro information supplied from the analysis unit 323-3.

In step S299, the rewriting unit 324-3 outputs the rewritten slice data as the valid data to the combining unit 302-2. Then, the process ends.

Conversely, when it is determined in step S294 that the data supplied from the decoding unit 321-3 is not the slice data, the process ends.

The fourth non-criterion process of step S251 of FIG. 30 is the same as the second non-criterion process of FIG. 32 except that when it is determined in step S294 of the second non-criterion process of FIG. 32 that the data is not the slice data, it is further determined whether the data is the delimiter, and when the data is the delimiter, the data is selected as the valid data and the process proceeds to step S299, and that the head macro information is not determined and is not rewritten. Since the sixth non-criterion process of step S251 is the same as the second non-criterion process in FIG. 32, the description will be omitted.

FIG. 33 is a flowchart for describing the details of the output process in step S253 of FIG. 30.

Since the processes of step S311 to step S314 of FIG. 33 are the same as the processes of step S71 to step S74 of FIG. 8, the description will be omitted.

When the switching unit 303 determines in step S313 that the PPS of the criterion stream is not supplied, the switching unit 303 determines in step S315 whether the slice data is supplied from the combining unit 302-1.

When the switching unit 303 determines in step S315 that the slice data is supplied from the combining unit 302-1, the switching unit 303 outputs the slice data as the multi-stream in step S316.

In step S317, the switching unit 303 determines whether the slice data is supplied from the combining unit 302-2.

When the switching unit 303 determines in step S317 that the slice data is not supplied from the combining unit 302-2, the switching unit 303 waits until the slice data is supplied from the combining unit 302-2.

Conversely, when the switching unit 303 determines in step S317 that the slice data is supplied from the combining unit 302-2, the switching unit 303 outputs the slice data as the multi-stream in step S318. Then, the process returns to the process of step S253 of FIG. 30 and proceeds to step S254.

When it is determined in step S315 that the slice data is not supplied from the combining unit 302-1, the process proceeds to step S319 to perform the same process as the process of step S79 of FIG. 8. Then, in step S320, the same process as the process of step S80 of FIG. 8 is performed.

In step S321, the switching unit 303 determines whether the slice data is supplied from the combining unit 302-3. When the switching unit 303 determines in step S321 that the slice data is not supplied from the combining unit 302-3, the switching unit 303 waits until the slice data is supplied from the combining unit 302-3.

Conversely, when the switching unit 303 determines in step S321 that the slice data is supplied from the combining unit 302-3, the switching unit 303 outputs the slice data as the multi-stream in step S322.

In step S323, the switching unit 303 determines whether the slice data is supplied from the combining unit 302-4. When the switching unit 303 determines in step S323 that the slice data is not supplied from the combining unit 302-4, the switching unit 303 waits until the slice data is supplied from the combining unit 302-4.

Conversely, when the switching unit 303 determines in step S323 that the slice data is supplied from the combining unit 302-4, the switching unit 303 outputs the slice data as the multi-stream in step S324.

In step S325, the switching unit 303 determines whether the delimiter of the non-criterion stream is supplied from the rewriting unit 324-5 of the processing unit 301-5. When the switching unit 303 determines in step S325 that the delimiter of the non-criterion stream is not supplied from the rewriting unit 324-5, the switching unit 303 waits until the delimiter of the non-criterion stream is supplied from the rewriting unit 324-5.

Conversely, when the switching unit 303 determines in step S325 that the delimiter of the non-criterion stream is supplied, the switching unit 303 outputs the delimiter of the non-criterion stream as the multi-stream in step S326. Then, the process returns to the process of step S253 of FIG. 30 and proceeds to step S254.

As described above, the image processing device 282 generates the multi-stream according to the method of multiplexing the slice data included in the criterion stream and the non-criterion stream in the horizontal direction, the vertical direction, and the time direction as a method corresponding to the process of dividing the image data of the plurality of image files obtained as the decoding result of the multi-stream in the vertical direction, the time direction, and the horizontal direction and deletes the image data of the dummy images to form the image data of each image file. Thus, the multi-stream can be generated merely by combining the data portions of the slice data of the criterion stream and the non-criterion stream and adding the slice header.

Even in the fourth embodiment, the restriction that the SPSs and the PPSs of the criterion stream and the non-criterion stream be the same may not be imposed, as in the first embodiment.

When the performance or the specification of a decoder is obvious, the temporarily generated multi-stream may not necessarily satisfy hypothetical reference decoder (HRD) conformance. Therefore, in the first to fourth embodiments, a process is not performed to use the HRD conformance. However, when it is necessary for the multi-stream to satisfy the HRD conformance, the syntax of Buffering Period SEI and Picture Timing SEI of the multi-stream may be updated.

Further, the decoding device that decodes the multi-stream may be, for example, a consumer electronics (CE) device capable of decoding one encoded stream as well as a mobile terminal.

### Fifth Embodiment

<Explanation of Computer to which the Present Technology is Applied>

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

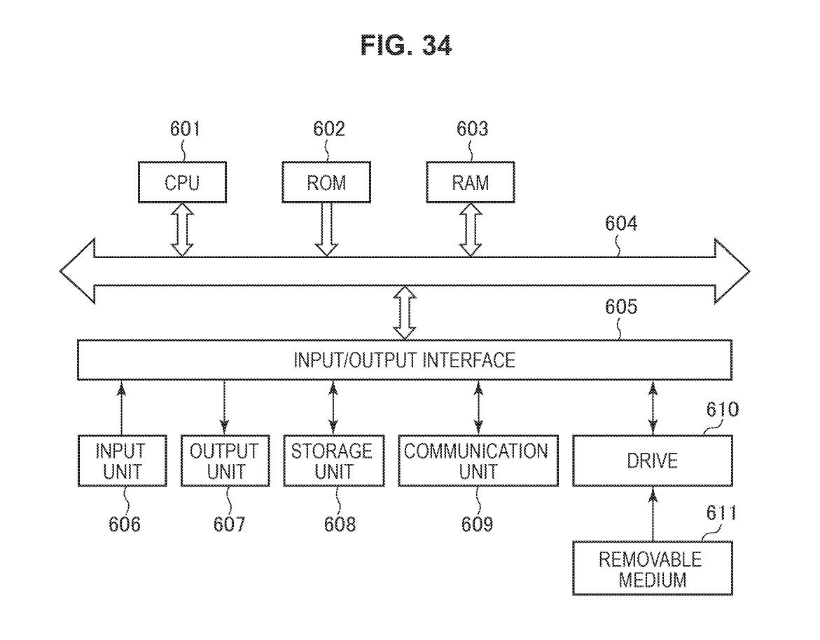

FIG. 34 is a block diagram showing a hardware configuration example of a computer that performs the above-described series of processing using a program.

In the computer, a central processing unit (CPU) 601, a read only memory (ROM) 602 and a random access memory (RAM) 603 are mutually connected by a bus 604.

An input/output interface 605 is also connected to the bus 604. An input unit 606, an output unit 607, a storage unit 608, a communication unit 609, and a drive 610 are connected to the input/output interface 605.

The input unit 606 is configured from a keyboard, a mouse, a microphone or the like. The output unit 607 is configured from a display, a speaker or the like. The storage unit 608 is configured from a hard disk, a non-volatile memory or the like. The communication unit 609 is configured from a network interface or the like. The drive 610 drives a removable medium 611 such as a magnetic disk, an optical disk, a magneto-optical disk, a semiconductor memory or the like.

In the computer configured as described above, the CPU 601 loads a program that is stored, for example, in the storage unit 608 onto the RAM 603 via the input/output interface 605 and the bus 604, and executes the program. Thus, the above-described series of processing is performed.

Programs to be executed by the computer (the CPU 601) are provided being recorded in the removable medium 611 which is a packaged medium or the like. Also, programs may be provided via a wired or wireless transmission medium, such as a local area network, the Internet or digital satellite broadcasting.

In the computer, by inserting the removable medium 611 into the drive 610, the program can be installed in the storage unit 608 via the input/output interface 605. Further, the program can be received by the communication unit 609 via a wired or wireless transmission medium and installed in the storage unit 608. Moreover, the program can be installed in advance in the 5OM 602 or the storage unit 608.

It should be noted that the program executed by the computer may be a program that is processed in time series according to the sequence described in this specification or a program that is processed in parallel or at necessary timing such as upon calling.

Further, in the present technology, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present technology can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Any two embodiments of the first to third embodiments may be combined. Further, the post-processing unit 32 (121, 221, 291) may perform a process of effect, transition, rotation, or the like on the image data of each image file.

Additionally, the present technology may also be configured as below.

(1) An image processing device including:

a generation unit configured to generate a combined stream, which is one encoded stream of a plurality of images generated from encoded streams of the plurality of images, from the encoded streams of the plurality of images according to a method corresponding to a process performed after decoding of the combined stream.

(2) The image processing device according to (1), wherein the generation unit generates the combined stream according to a method of multiplexing encoded data of the images included in the encoded streams in a time direction as a method corresponding to the process of dividing the plurality of images obtained as a decoding result of the combined stream in the time direction to form images of the encoded streams.
(3) The image processing device according to (2), wherein the generation unit generates the combined stream according to a method of multiplexing the encoded data in the time direction and changing a header added to the encoded data.
(4) The image processing device according to any one of (1) to (3), wherein the generation unit generates the combined stream according to a method of multiplexing encoded data of the images included in the encoded streams in a vertical direction as a method corresponding to the process of dividing the plurality of images obtained as a decoding result of the combined stream in the vertical direction to form images of the encoded streams.
(5) The image processing device according to (4), wherein the generation unit generates the combined stream according to a method of multiplexing the encoded data in the vertical direction and changing a header added to the encoded data.
(6) The image processing device according to (4) or (5), wherein the generation unit generates the combined stream according to a method of generating the encoded data in units of slices included in the encoded streams of the plurality of images as encoded data in the units of slices of one picture included in the combined stream.
(7) The image processing device according to any one of (1) to (6),

wherein the encoded streams are encoded streams of the images to which dummy images are added, and

wherein the generation unit generates the combined stream according to a method of multiplexing encoded data of the images, to which the dummy images are added, included in the encoded streams in a horizontal direction as a method corresponding to the process of dividing the plurality of images obtained as a decoding result of the combined stream in the horizontal direction and deleting the dummy images to form images of the encoded streams.

(8) The image processing device according to (7), wherein the dummy images are added to both ends of the image in the horizontal direction.
(9) The image processing device according to (7), wherein the encoded stream is an encoded stream encoded in a manner that a quantization parameter of each dummy image is a constant value.
(10) An image processing method including:

generating, by an image processing device, a combined stream, which is one encoded stream of a plurality of images generated from encoded streams of the plurality of images, from the encoded streams of the plurality of images according to a method corresponding to a process performed after decoding of the combined stream.

(11) A program causing a computer to function as:

a generation unit configured to generate a combined stream, which is one encoded stream of a plurality of images generated from encoded streams of the plurality of images, from the encoded streams of the plurality of images according to a method corresponding to a process performed after decoding of the combined stream.

What is claimed is:

1. An image processing device comprising:
a generation unit configured to generate a combined stream, which is one encoded stream of a plurality of images generated from encoded streams of the plurality of images, from the encoded streams of the plurality of images according to a method corresponding to a process performed after decoding of the combined stream.

2. The image processing device according to claim 1, wherein the generation unit generates the combined stream according to a method of multiplexing encoded data of the images included in the encoded streams in a time direction as a method corresponding to the process of dividing the plurality of images obtained as a decoding result of the combined stream in the time direction to form images of the encoded streams.

3. The image processing device according to claim 2, wherein the generation unit generates the combined stream according to a method of multiplexing the encoded data in the time direction and changing a header added to the encoded data.

4. The image processing device according to claim 1, wherein the generation unit generates the combined stream according to a method of multiplexing encoded data of the images included in the encoded streams in a vertical direction as a method corresponding to the process of dividing the plurality of images obtained as a decoding result of the combined stream in the vertical direction to form images of the encoded streams.

5. The image processing device according to claim 4, wherein the generation unit generates the combined stream according to a method of multiplexing the encoded data in the vertical direction and changing a header added to the encoded data.

6. The image processing device according to claim 4, wherein the generation unit generates the combined stream according to a method of generating the encoded data in units of slices included in the encoded streams of the plurality of images as encoded data in the units of slices of one picture included in the combined stream.

7. The image processing device according to claim 1,
wherein the encoded streams are encoded streams of the images to which dummy images are added, and
wherein the generation unit generates the combined stream according to a method of multiplexing encoded data of the images, to which the dummy images are added, included in the encoded streams in a horizontal direction as a method corresponding to the process of dividing the plurality of images obtained as a decoding result of the combined stream in the horizontal direction and deleting the dummy images to form images of the encoded streams.

8. The image processing device according to claim 7, wherein the dummy images are added to both ends of the image in the horizontal direction.

9. The image processing device according to claim 7, wherein the encoded stream is an encoded stream encoded in a manner that a quantization parameter of each dummy image is a constant value.

10. An image processing method comprising:
generating, by an image processing device, a combined stream, which is one encoded stream of a plurality of images generated from encoded streams of the plurality of images, from the encoded streams of the plurality of images according to a method corresponding to a process performed after decoding of the combined stream.

11. A program causing a computer to function as:
a generation unit configured to generate a combined stream, which is one encoded stream of a plurality of images generated from encoded streams of the plurality of images, from the encoded streams of the plurality of images according to a method corresponding to a process performed after decoding of the combined stream.
